(19) United States
(12) Patent Application Publication
(10) Pub. No.: US 2026/0332869 A1
(43) Pub. Date: Oct. 22, 2026

(54) CAMERA MODULE

(71) Applicant: Samsung Electro-Mechanics Co., Ltd., Suwon-si (KR)

(72) Inventors: Bo Sung SEO, Suwon-si (KR); Nam Ju LEE, Suwon-si (KR)

(73) Assignee: Samsung Electro-Mechanics Co., Ltd., Suwon-si (KR)

(21) Appl. No.: 19/644,188

(22) Filed: Apr. 10, 2026

(30) Foreign Application Priority Data
Apr. 18, 2025 (KR) 10-2025-0051104
Mar. 6, 2026 (KR) 10-2026-0040858

(51) Int. Cl. H04N 23/54; G02B 7/02; G02B 7/10; G02B 27/64; G03B 5/02; G03B 13/36; H04N 23/52; H04N 23/57

(52) U.S. Cl. CPC H04N 23/54; G02B 7/023; G02B 7/10; G02B 27/646; G03B 5/02; G03B 13/36; H04N 23/52; H04N 23/57; G03B 2205/0015; G03B 2205/0069

(57) ABSTRACT

A camera module an AF carrier disposed to be movable in an optical axis direction; an OIS carrier disposed to be movable in a direction perpendicular to the optical axis direction; an AF actuator including an AF magnet and an AF coil disposed to face each other in a first axis direction; and an OIS actuator including a plurality of OIS magnets and a plurality of OIS coils disposed to face each other, wherein the plurality of OIS coils include two OIS coils spaced apart from the AF magnet in the first axis direction, the two OIS coils are spaced apart from each other by a separation space in a second axis direction, and when viewed in the first axis direction, a center of the AF magnet in the second axis direction is spaced apart from the separation space between the two OIS coils in the second axis direction.

### CROSS-REFERENCE TO RELATED APPLICATIONS

This application claims the benefit under 35 USC 119(a) of Korean Patent Application Nos. 10-2025-0051104 filed on Apr. 18, 2025, and 10-2026-0040858 filed on Mar. 6, 2026, in the Korean Intellectual Property Office, the entire disclosures of which are incorporated herein by reference for all purposes.

### BACKGROUND

### 1. Field

The present disclosure relates to a camera module.

### 2. Description of Background

Recently, camera modules have been adopted for use in mobile communication terminals such as smartphones, tablet PCs, and laptops. Such camera modules are equipped with actuators having a focus adjustment function in order to generate high-resolution images.

A thickness of a mobile communication terminal is gradually decreasing, and a thickness of the camera module for use therein also needs to be reduced accordingly.

However, due to various factors required for capturing high-resolution images, it is difficult to reduce the thickness of camera modules.

In particular, when the thickness of a camera module is reduced, it becomes difficult to ensure operational stability during focus adjustment.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing; an AF carrier disposed to be movable relative to the housing in an optical axis direction; an OIS carrier disposed to be movable relative to the housing in a direction perpendicular to the optical axis direction; an AF actuator configured to generate a driving force in the optical axis direction and including an AF magnet and an AF coil disposed to face each other in a first axis direction perpendicular to the optical axis direction; and an OIS actuator configured to generate a driving force in a direction perpendicular to the optical axis direction and including a plurality of OIS magnets and a plurality of OIS coils disposed to face each other, wherein the plurality of OIS coils include two OIS coils spaced apart from the AF magnet in the first axis direction, the two OIS coils are spaced apart from each other by a separation space in a second axis direction perpendicular to both the optical axis direction and the first axis direction, and when viewed in the first axis direction, a center of the AF magnet in the second axis direction is spaced apart from the separation space between the two OIS coils in the second axis direction.

The plurality of OIS magnets may include a first OIS magnet and a second OIS magnet, the plurality of OIS coils may include a first OIS coil portion facing the first OIS magnet and a second OIS coil portion facing the second OIS magnet, the first OIS coil portion may include a first sub-coil constituted by one of the two OIS coils and a second sub-coil constituted by another one of the two OIS coils, and the first OIS magnet may be spaced apart from the AF magnet in the first axis direction.

A distance in the second axis direction between the separation space between the first sub-coil and the second sub-coil and one surface of the second OIS magnet may be smaller than a distance in the second axis direction between the center of the AF magnet and the one surface of the second OIS magnet.

A distance in the second axis direction between the center of the AF magnet and one surface of the second OIS magnet may be greater than a distance in the second axis direction between a center of the first OIS magnet and the one surface of the second OIS magnet.

When viewed in the first axis direction, the center of the AF magnet and a center of the first OIS magnet may be spaced apart from each other in the second axis direction.

A ratio of a length of the first OIS magnet in the second axis direction to a length of the AF magnet in the second axis direction may be greater than or equal to 0.5 and less than or equal to 1.

The camera module may further include a first position sensor configured to detect a position of the first OIS magnet; and a second position sensor configured to detect a position of the second OIS magnet, wherein the first position sensor may include a plurality of position sensors.

The second OIS coil portion may include a third sub-coil and a fourth sub-coil spaced apart from each other in the first axis direction, a length of the third sub-coil in the first axis direction and a length of the fourth sub-coil in the first axis direction may be different from each other, and the second position sensor may be disposed at a position spaced apart in the first axis direction from a center of a sub-coil having a greater length in the first axis direction among the third sub-coil and the fourth sub-coil.

A position of the second position sensor in the first axis direction may be between a center of the third sub-coil and a center of the fourth sub-coil.

The camera module may further include a first support guide and a second support guide configured to support movement of the AF carrier in the optical axis direction and spaced apart from each other in the direction perpendicular to the optical axis direction, wherein a position of the second support guide in the optical axis direction may be between opposite ends of the first support guide in the optical axis direction, and the center of the AF magnet may be disposed closer to the first support guide than to the second support guide.

A distance in the second axis direction between the center of the AF magnet and the first support guide may be different from a distance in the second axis direction between the separation space between the two OIS coils and the first support guide.

The camera module may further include a lens barrel; and a plurality of lenses disposed in the lens barrel, wherein the lens barrel may be disposed to be movable in the optical axis direction together with the AF carrier, the lens barrel may be disposed to be movable in the direction perpendicular to the optical axis direction together with the OIS carrier, and the center of the AF magnet and a center of the lens barrel may be spaced apart from each other in the second axis direction.

The camera module may further include a lens barrel; a plurality of lenses disposed in the lens barrel; and an image sensor including an imaging surface on which light passing through the plurality of lenses disposed in the lens barrel is received, wherein, when viewed in the optical axis direction, the center of the AF magnet may be disposed at a position spaced apart from a center of the imaging surface in both the first axis direction and the second axis direction.

In another general aspect, a camera module includes a housing; an AF carrier disposed to be movable relative to the housing in an optical axis direction; an OIS carrier disposed to be movable relative to the housing in a direction perpendicular to the optical axis direction; an AF actuator configured to generate a driving force in the optical axis direction and including an AF magnet and an AF coil disposed to face each other in a first axis direction perpendicular to the optical axis direction; and an OIS actuator configured to generate a driving force in the direction perpendicular to the optical axis direction, wherein the OIS actuator includes a first image stabilization actuator including a first OIS magnet and a first OIS coil portion disposed to face each other, and a second OIS magnet and a second OIS coil portion disposed to face each other, the first OIS coil portion is spaced apart from the AF magnet in the first axis direction, the first OIS coil portion includes a first sub-coil and a second sub-coil spaced apart from each other by a separation space in a second axis direction perpendicular to both the optical axis direction and the first axis direction, a distance in the second axis direction between a center of the AF magnet and one side surface of the housing is smaller than a distance in the second axis direction between the separation space between the first sub-coil and the second sub-coil and the one side surface of the housing, and the one side surface of the housing is a side surface closest to the AF magnet among side surfaces of the housing that are perpendicular to the AF magnet.

The camera module may further include a first support guide and a second support guide configured to support movement of the AF carrier in the optical axis direction and spaced apart from each other in the direction perpendicular to the optical axis direction, wherein the AF magnet may be disposed closer to the first support guide than to the second support guide, and a distance in the second axis direction between the center of the AF magnet and the first support guide may be smaller than a distance in the second axis direction between the separation space between the first sub-coil and the second sub-coil and the first support guide.

Other features and aspects will be apparent from the following detailed description, the drawings, and the claims.

### BRIEF DESCRIPTION OF DRAWINGS

FIG. 1 is a perspective view illustrating a camera module according to an embodiment in the present disclosure.

FIG. 2 is an exploded perspective view of the camera module of FIG. 1.

FIG. 3 is an exploded perspective view of a housing, an AF carrier, and an OIS carrier of FIG. 2.

FIG. 4 is a bottom perspective view of the OIS carrier of FIG. 3.

FIG. 5 is a side view of the AF carrier of FIG. 3.

FIG. 6 is a perspective view of a first image stabilization actuator and a second image stabilization actuator of FIG. 3.

FIG. 7 is a plan view of the OIS carrier and the second image stabilization actuator of FIG. 3.

FIGS. 8-10 are plan views of a first actuator and a second actuator of FIG. 3.

FIG. 11 is an exploded perspective view of the housing, the AF carrier, and the OIS carrier of FIG. 2 including a modified example of a first guide unit.

FIG. 12 is a perspective view of a camera module according to another embodiment in the present disclosure.

FIG. 13 is a plan view of the camera module of FIG. 2 with a case removed.

FIG. 14 is a perspective view of the camera module of FIG. 2 with the case removed.

FIG. 15 is an exploded perspective view of the camera module of FIG. 12.

FIG. 16 is an exploded perspective view of a lens module and an AF carrier of FIG. 15.

FIG. 17 is a plan view of the lens module and the AF carrier of FIG. 15.

FIG. 18 is an exploded perspective view of the lens module, the AF carrier, an OIS carrier, and a first actuator of FIG. 15.

FIG. 19 is a plan view of the lens module, the AF carrier, the OIS carrier, and the first actuator of FIG. 15.

FIG. 20 is a cross-sectional view taken along line XX-XX' of FIG. 12.

FIG. 21 is a diagram illustrating a rotational moment generated in the camera module of FIG. 12.

FIG. 22 is an exploded perspective view of a housing, the OIS carrier, and a second actuator of FIG. 15.

FIG. 23 is a bottom exploded perspective view of the housing, the OIS carrier, and the second actuator of FIG. 15.

FIGS. 24 and 25 are plan views of the first actuator and a first image stabilization actuator of FIG. 15.

FIG. 26 is a perspective view of a connection substrate of FIG. 15.

FIG. 27 is a plan view of the connection substrate of FIG. 15 in a coupled state.

FIG. 28 is a plan view illustrating positions of a first guide unit and a second guide unit of FIG. 15.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as "above," "upper," "below," and "lower" may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being "above" or "upper" relative to another element will then be "below" or "lower" relative to the other element. Thus, the term "above" encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

In the present specification, an optical axis (Z-axis) direction may mean a direction in which an optical axis (Z-axis) of a lens module 200 extends upwardly and downwardly, or in a direction parallel to the optical axis (Z-axis).

A first axis (X-axis) direction may mean a direction perpendicular to the optical axis (Z-axis) direction, and a second axis (Y-axis) direction may mean a direction perpendicular to both the optical axis (Z-axis) direction and the first axis (X-axis) direction.

The present disclosure relates to a camera module, and the camera module may be mounted in a portable electronic device such as a mobile communication terminal, a smartphone, or a tablet PC.

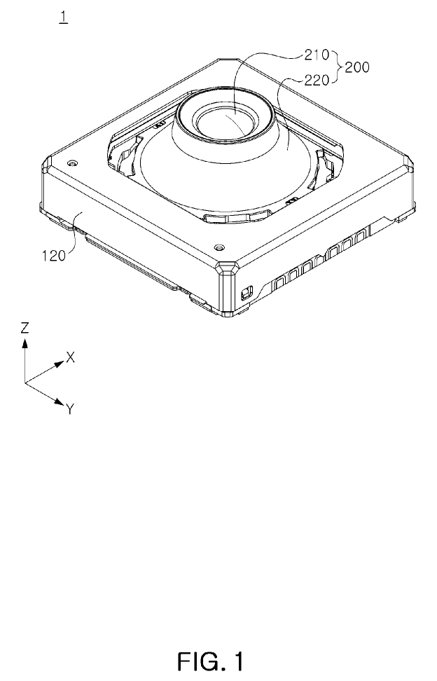

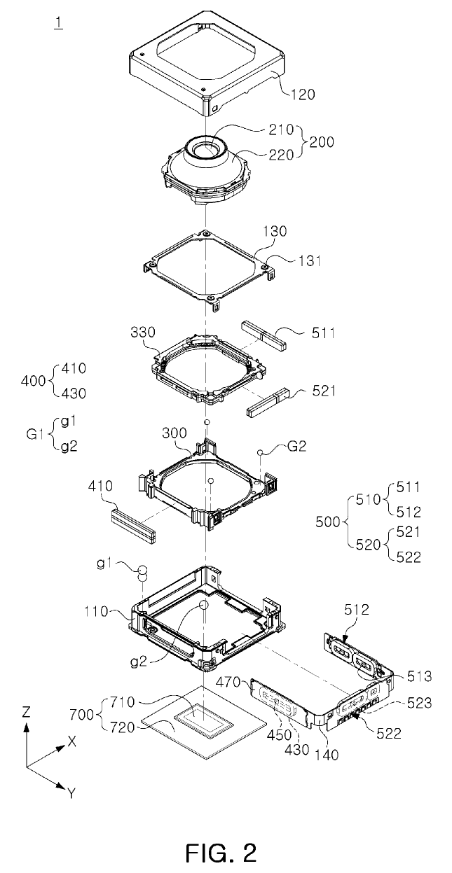

FIG. 1 is a perspective view illustrating a camera module according to an embodiment in the present disclosure, and FIG. 2 is an exploded perspective view of the camera module of FIG. 1.

Referring to FIGS. 1 and 2, a camera module 1 according to an embodiment of the present disclosure includes an optical module and a housing 110.

In the present specification, an optical module may be understood as including either one or both of a lens module 200 and an image sensor module 700. For example, in an embodiment, the optical module may mean a lens module 200, and in another embodiment, the optical module may mean an image sensor module 700.

The lens module 200 includes one or more lenses 210 and a lens barrel 220 accommodating the one or more lenses 210.

The lens barrel 220 may have a hollow cylindrical shape, and the one or more lenses 210 may be disposed inside the lens barrel 220.

When a plurality of lenses 210 are provided, the plurality of lenses 210 may be mounted inside the lens barrel 220 in the optical axis (Z-axis) direction.

The camera module 1 may further include an OIS carrier 330. In this case, the lens barrel 220 may be coupled to the OIS carrier 330. For reference, "OIS" may mean optical image stabilization.

The OIS carrier 330 may move relative to the housing 110 in a direction perpendicular to the optical axis (Z-axis) direction. Since the lens barrel 220 is coupled to the OIS carrier 330, the lens barrel 220 may be moved together with the OIS carrier 330 in the direction perpendicular to the optical axis (Z-axis) direction.

That is, the lens module 200 and the OIS carrier 330 may be moved in the direction perpendicular to the optical axis (Z-axis) direction to perform image stabilization during image capture.

The camera module 1 may further include an AF carrier 300. The AF carrier 300 is disposed in the housing 110 and may move relative to the housing 110 in the optical axis (Z-axis) direction. The lens module 200 and the OIS carrier 330 may be disposed in the AF carrier 300. Accordingly, the lens module 200, the OIS carrier 330, and the AF carrier 300 may move together in the optical axis (Z-axis) direction.

That is, a distance between the lens module 200 and an image sensor 710 may be changed to adjust a focus.

For reference, "AF" may mean autofocus.

The housing 110 has a shape in which an upper portion and a lower portion are open, the AF carrier 300 is disposed in an internal space of the housing 110, and the lens module 200 and the OIS carrier 330 may be accommodated in the AF carrier 300.

A case 120 is coupled to the housing 110 so as to surround an outer surface of the housing 110 and functions to protect internal components of the camera module 1.

The image sensor module 700 is a device converting light incident through the lens module 200 into an electrical signal.

As an example, the image sensor module 700 may include the image sensor 710 and a printed circuit board 720 connected to the image sensor 710 and may further include an infrared filter (not shown).

The infrared filter may serve to cut off light in an infrared region in light incident thereto through the lens module 200.

The image sensor 710 converts light incident through the lens module 200 and the filter into an electrical signal. For example, the image sensor 710 may be a charge-coupled device (CCD) or a complementary metal-oxide-semiconductor (CMOS) device.

The image sensor 710 has an imaging surface on which light passing through the lens module 200 is received.

The electrical signal converted by the image sensor 710 is output as an image through a display unit of a portable electronic device.

The image sensor 710 is fixed to the printed circuit board 720 and is electrically connected to the printed circuit board 720 by wire bonding.

The image sensor module 700 is disposed under the housing 110.

A stopper 130 is coupled to the AF carrier 300. The stopper 130 is coupled to the AF carrier 300 so as to cover at least a portion of an upper surface of the OIS carrier 330.

The stopper 130 may prevent the OIS carrier 330 from being separated from the AF carrier 300 due to an external impact or other disturbance.

A buffer member 131 having an elastic property may be coupled to each corner portion of the stopper 130.

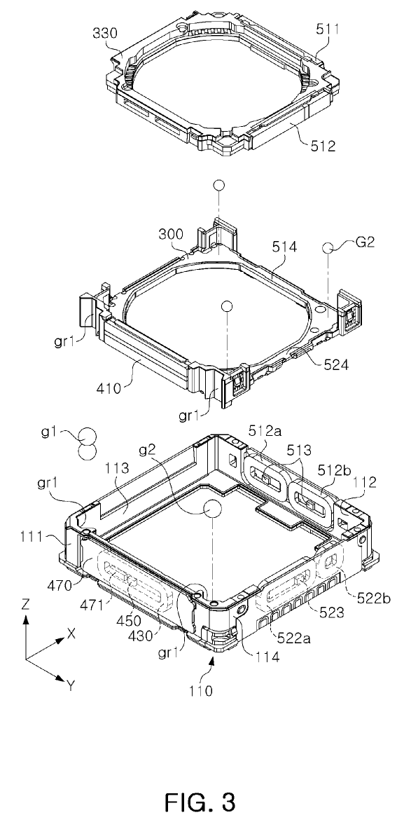

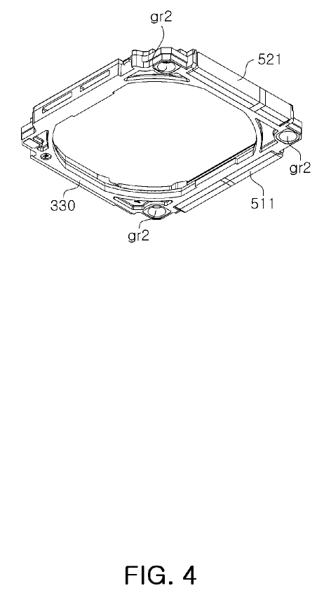

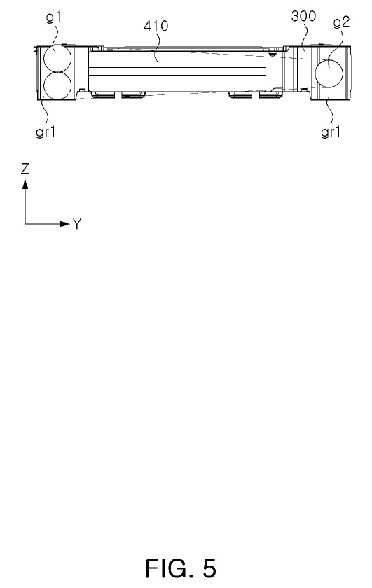

FIG. 3 is an exploded perspective view of a housing, an AF carrier, and an OIS carrier of FIG. 2, FIG. 4 is a bottom perspective view of the OIS carrier of FIG. 3, and FIG. 5 is a side view of the AF carrier of FIG. 3.

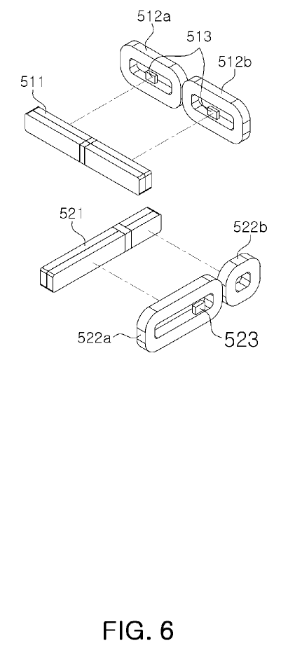

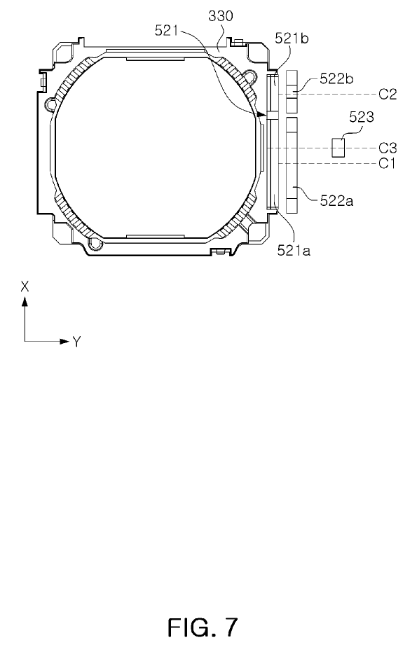

FIG. 6 is a perspective view of a first image stabilization unit and a second image stabilization actuator of FIG. 3, and FIG. 7 is a plan view of the OIS carrier and the second image stabilization actuator of FIG. 3.

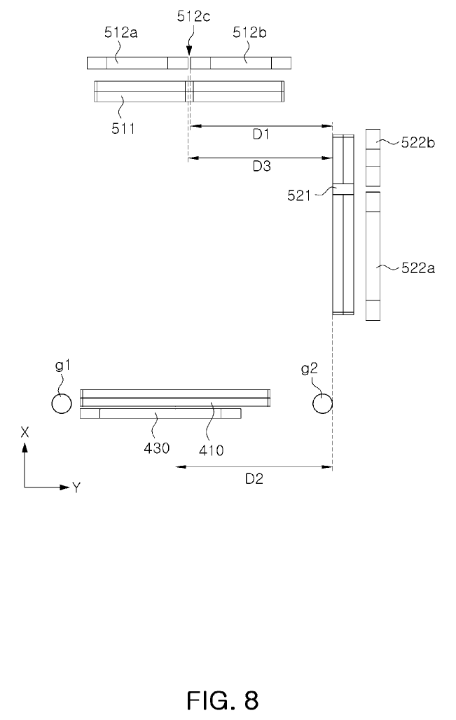

FIGS. 8-10 are plan views of a first actuator and a second actuator of FIG. 3.

The camera module 1 may include a first actuator 400. The lens module 200 may be moved in the optical axis (Z-axis) direction by the first actuator 400.

For example, the first actuator 400 may generate a driving force in the optical axis (Z-axis) direction to move the AF carrier 300 in the optical axis (Z-axis) direction. Since the lens module 200 and the OIS carrier 330 are disposed in the AF carrier 300, the AF carrier 300, the lens module 200, and the OIS carrier 330 may be moved together in the optical axis (Z-axis) direction by the driving force of the first actuator 400.

The first actuator 400 includes an AF magnet 410 and an AF coil 430. The AF magnet 410 and an AF coil 430 may be disposed to face each other in a direction perpendicular to the optical axis (Z-axis) direction. For example, the AF magnet 410 and the AF coil 430 may face each other in the first axis (X-axis) direction.

One of the AF magnet 410 and the AF coil 430 may be disposed on the AF carrier 300, and the other one of the AF magnet 410 and the AF coil 430 may be disposed on the housing 110. Hereinafter, a description will be given based on an embodiment in which the AF magnet 410 is disposed on the AF carrier 300.

The AF magnet 410 is mounted on the AF carrier 300. As an example, the AF magnet 410 may be mounted on a side surface of the AF carrier 300 facing in the first axis (X-axis) direction.

The AF magnet 410 may be magnetized so that one surface (for example, the surface facing the AF coil 430) of the AF magnet 410 has both an N-pole and an S-pole. As an example, the N-pole, a neutral region, and the S-pole may be sequentially provided on one surface of the AF magnet 410 facing the AF coil 430 in the optical axis (Z-axis) direction.

In the present specification, a first polarity may mean the N-pole or the S-pole, and a second polarity may mean a polarity opposite to the first polarity.

The AF coil 430 is disposed to face the AF magnet 410. For example, the AF coil 430 may be disposed to face the AF magnet 410 in a direction perpendicular to the optical axis (Z-axis) direction, which in this embodiment is the first axis (X-axis) direction.

The AF coil 430 is disposed on a substrate 140, and the substrate 140 is mounted on the housing 110 so that the AF magnet 410 and the AF coil 430 face each other in the direction perpendicular to the optical axis (Z-axis) direction. As an example, the AF coil 430 may be disposed on one surface of the substrate 140. The substrate 140 is mounted on a side surface of the housing 110 so that the AF magnet 410 and the AF coil 430 face each other in the direction perpendicular to the optical axis (Z-axis) direction.

An opening penetrating the side surface of the housing 110 is provided in the side surface of the housing 110, and the AF coil 430 disposed on the substrate 140 may directly face the AF magnet 410 through the opening.

In an embodiment, the housing 110 includes a first side surface 111, a second side surface 112, a third side surface 113, and a fourth side surface 114. Each side surface may extend from a bottom surface of the housing 110 in the optical axis (Z-axis) direction.

The first side surface 111 and the second side surface 112 are disposed opposite to each other, and the third side surface 113 and the fourth side surface 114 are disposed opposite to each other.

The first side surface 111 and the second side surface 112 are perpendicular to the third side surface 113 and the fourth side surface 114.

The AF coil 430 is disposed on the first side surface 111, and the opening is provided in the first side surface 111.

During the focus adjustment, the AF magnet 410 is a moving member mounted on the AF carrier 300 and moving together with the AF carrier 300 in the optical axis (Z-axis) direction, and the AF coil 430 is a fixed member fixed to the substrate 140.

When power is applied to the AF coil 430, the AF carrier 300 may be moved in the optical axis (Z-axis) direction by an electromagnetic force generated between the AF magnet 410 and the AF coil 430.

Since the lens module 200 and the OIS carrier 330 are accommodated in the AF carrier 300, the lens module 200 and the OIS carrier 330 are also moved in the optical axis (Z-axis) direction by the movement of the AF carrier 300.

A first guide unit G1 is disposed between the AF carrier 300 and the housing 110. The first guide unit G1 may guide the movement of the AF carrier 300.

The first guide unit G1 includes a first support guide g1 and a second support guide g2 spaced apart from each other in a direction perpendicular to the optical axis (Z-axis) direction, which in this embodiment is the second axis (Y-axis) direction.

In an embodiment, the first guide unit G1 may include a plurality of balls. The plurality of balls may roll in the optical axis (Z-axis) direction when the AF carrier 300 moves in the optical axis (Z-axis) direction.

For example, the first support guide g1 and the second support guide g2 may each include one or more balls.

The first support guide g1 may function as a main guide guiding the movement of the lens module 200 in the optical axis (Z-axis) direction.

The second support guide g2 may function as an auxiliary guide supporting the movement of the lens module 200 in the optical axis (Z-axis) direction.

A position of the second support guide g2 in the optical axis (Z-axis) direction may be between opposite ends of the first support guide g1 in the optical axis (Z-axis) direction.

A first yoke 470 may be disposed on the housing 110. The first yoke 470 may be disposed at a position spaced apart from the AF magnet 410 in the first axis (X-axis) direction. For example, the AF coil 430 may be disposed on one surface of the substrate 140, and the first yoke 470 may be disposed on the other surface of the substrate 140.

The AF magnet 410 and the first yoke 470 may generate an attractive force therebetween. For example, the first yoke 470 may be made of a magnetic material. The attractive force acts between the AF magnet 410 and the first yoke 470 in a direction perpendicular to the optical axis (Z-axis) direction, which in this embodiment is the first axis (X-axis) direction.

Accordingly, the AF carrier 300 and the housing 110 may be held in contact with the first guide unit G1 by the attractive force generated between the AF magnet 410 and the first yoke 470.

A first guide groove gr1 may be formed in either one or both of the AF carrier 300 and the housing 110.

For example, the first guide groove gr1 may be formed in each of a surface of the AF carrier 300 and a surface of the housing 110 facing each other.

The first guide groove gr1 extends in the optical axis (Z-axis) direction. The first support guide g1 and the second support guide g2 are disposed in the first guide groove gr1.

The first support guide g1 and the second support guide g2 are spaced apart from each other in a direction perpendicular to the optical axis (Z-axis) direction, which in this embodiment is the second axis (Y-axis) direction. The first support guide g1 includes the plurality of balls disposed in the optical axis (Z-axis) direction. The second support guide g2 includes a smaller number of balls than the first support guide g1.

For example, the first support guide g1 includes two or more balls disposed in the optical axis (Z-axis) direction, and the second support guide g2 includes a smaller number of balls than the first support guide g1. The number of balls may be changed as long as the number of balls in the first support guide g1 is different from the number of balls in the second support guide g2.

In an embodiment, on the side surface of the AF carrier 300, the AF magnet 410 may be offset toward one side of the AF carrier 300 along a longitudinal direction (for example, the first axis (X-axis) direction) of the AF magnet 410.

For example, referring to FIG. 5, the AF magnet 410 may be disposed to be closer to the first support guide g1 (the main guide) than to the second support guide g2 (the auxiliary guide).

In an embodiment, an auxiliary yoke 471 may be disposed at a position facing the AF magnet 410. The auxiliary yoke 471 may be fixedly disposed relative to the housing 110. For example, the auxiliary yoke 471 may be disposed on the substrate 140 so as to face the AF magnet 410.

The auxiliary yoke 471 may be disposed in a hole of the AF coil 430.

The auxiliary yoke 471 may be disposed closer to the main guide than to the auxiliary guide. For example, the auxiliary yoke 471 may be disposed closer to the first support guide g1 having a larger number of balls (the main guide) than to the second support guide g2 (the auxiliary guide) having a smaller number of balls.

The auxiliary yoke 471 is made of a material capable of generating an attractive force with the AF magnet 410.

Accordingly, a resultant force of the attractive force generated between the AF magnet 410 and the first yoke 470 and the attractive force generated between the AF magnet 410 and the auxiliary yoke 471 may be disposed closer to the main guide than to the auxiliary guide.

In an embodiment, the camera module 1 may detect a position of the AF carrier 300 in the optical axis (Z-axis) direction.

For this purpose, a first position sensor 450 is provided. The first position sensor 450 is disposed on the substrate 140 so as to face the AF magnet 410. The first position sensor 450 may be a Hall sensor.

The camera module 1 may perform image stabilization during image capture by moving the lens module 200 in a direction perpendicular to the optical axis (Z-axis) direction. For this purpose, the camera module 1 includes a second actuator 500 moving the lens module 200 in the direction perpendicular to the optical axis (Z-axis) direction.

The lens module 200 and the OIS carrier 330 may be moved together in the direction perpendicular to the optical axis (Z-axis) direction by a driving force generated by the second actuator 500.

For example, the lens module 200 and the OIS carrier 330 may be moved together in the first axis (X-axis) direction and the second axis (Y-axis) direction.

The second actuator 500 includes a first image stabilization actuator 510 and a second image stabilization actuator 520. The first image stabilization actuator 510 may generate a driving force in the first axis (X-axis) direction, and the second image stabilization actuator 520 may generate a driving force in the second axis (Y-axis) direction.

The first image stabilization actuator 510 includes a first OIS magnet 511 and a first OIS coil portion 512. The first OIS magnet 511 and the first OIS coil portion 512 may be disposed to face each other in the first axis (X-axis) direction.

One of the first OIS magnet 511 and the first OIS coil portion 512 may be disposed on the OIS carrier 330, and the other one of the first OIS magnet 511 and the first OIS coil portion 512 may be disposed on the housing 110. Hereinafter, a description will be given based on an embodiment in which the first OIS magnet 511 is disposed on the OIS carrier 330.

The first OIS magnet 511 may be disposed on the OIS carrier 330. For example, the first OIS magnet 511 may be mounted on a side surface of the OIS carrier 330.

The first OIS magnet 511 may be magnetized so that one surface thereof has both an N-pole and an S-pole. As an example, the N-pole, a neutral region, and the S-pole may be sequentially provided on one surface of the first OIS magnet 511 along the second axis (Y-axis) direction. The first OIS magnet 511 has a shape having a length in the second axis (Y-axis) direction.

The other surface of the first OIS magnet 511 may be magnetized to have a polarity opposite to the polarity of the one surface of the first OIS magnet 511.

The first OIS coil portion 512 may be disposed to face the first OIS magnet 511. For example, the first OIS coil portion 512 may be disposed to face the first OIS magnet 511 in the first axis (X-axis) direction.

The first OIS coil portion 512 may be disposed on the second side surface 112 of the housing 110. An opening may be provided in the second side surface 112 of the housing 110.

The first OIS coil portion 512 may include two coils spaced apart from each other, and the two coils of the first OIS coil portion 512 may each have a donut shape having a hole.

In an embodiment, the first OIS coil portion 512 may include a first sub-coil 512a and a second sub-coil 512b. The first sub-coil 512a and the second sub-coil 512bmay be spaced apart from each other in the second axis (Y-axis) direction.

Accordingly, a separation space 512c (see FIGS. 8-10) may be formed between the first sub-coil 512a and the second sub-coil 512b.

One of the two coils of the first OIS coil portion 512 may be disposed to face the N-pole on the one surface of the first OIS magnet 511, and the other one of the two coils of the first OIS coil portion 512 may be disposed to face the S-pole on the one surface of the first OIS magnet 511.

For example, the polarity of the first OIS magnet 511 facing the first sub-coil 512a and the polarity of the first OIS magnet 511 facing the second sub-coil 512b may be different from each other.

Due to the polarity arrangement of the first OIS magnet 511 and the arrangement of the second OIS coil portion 512, a magnetic field leakage may be prevented, and thus a sufficient driving force may be generated even with a low power.

In the present embodiment, the first OIS magnet 511 is configured as a single magnet, but the first OIS magnet 511 may also be configured to include a plurality of magnets. In this case, one surface of each of the plurality of magnets may be configured to have one polarity.

During image stabilization, the first OIS magnet 511 is a moving member mounted on the OIS carrier 330, and the first OIS coil portion 512 is a fixed member fixed to the housing 110.

The first OIS magnet 511 and the first OIS coil portion 512 may generate a driving force in a direction (for example, the first axis (X-axis) direction) in which the first OIS magnet 511 and the first OIS coil portion 512 face each other.

When power is applied to the first OIS coil portion 512, the OIS carrier 330 and the lens module 200 may be moved in the first axis (X-axis) direction by an electromagnetic force generated between the first OIS magnet 511 and the first OIS coil portion 512.

The first OIS magnet 511 may be disposed at a position spaced apart from the AF magnet 410 in the first axis (X-axis) direction.

In addition, the two coils of the first OIS coil portion 512 may be disposed at positions spaced apart from the AF magnet 410 in the first axis (X-axis) direction. For example, the first sub-coil 512aand the second sub-coil 512b may be disposed to be spaced apart from the AF magnet 410 in the first axis (X-axis) direction.

When viewed in the first axis (X-axis) direction, a center of the AF magnet 410 in the second axis (Y-axis) direction may be spaced apart from the separation space 512c between the two coils of the first OIS coil portion 512 in the second axis (Y-axis) direction.

That is, when viewed in the first axis (X-axis) direction, the center of the AF magnet 410 in the second axis (Y-axis) direction may not overlap with the separation space 512c between the two coils of the first OIS coil portion 512.

For example, the separation space 512c is formed between the first sub-coil 512a and the second sub-coil 512b, and when viewed in the first axis (X-axis) direction, the center of the AF magnet 410 in the second axis (Y-axis) direction may be disposed to be spaced apart from the separation space 512c in the second axis (Y-axis) direction.

Referring to FIG. 8, a distance D1 in the second axis (Y-axis) direction between the separation space 512c between the first sub-coil 512a and the second sub-coil 512b and one surface of a second OIS magnet 521 to be described later may be smaller than a distance D2 in the second axis (Y-axis) direction between the center of the AF magnet 410 and the one surface of the second OIS magnet 521.

When viewed in the first axis (X-axis) direction, the center of the AF magnet 410 and a center of the first OIS magnet 511 may be spaced apart from each other in the second axis (Y-axis) direction.

The distance D2 in the second axis (Y-axis) direction between the center of the AF magnet 410 and the one surface of the second OIS magnet 521 may be greater than a distance D3 in the second axis (Y-axis) direction between the center of the first OIS magnet 511 and the one surface of the second OIS magnet 521.

The center of the first OIS magnet 511 may be located in the neutral region between the N-pole and the S-pole on the one surface of the first OIS magnet 511.

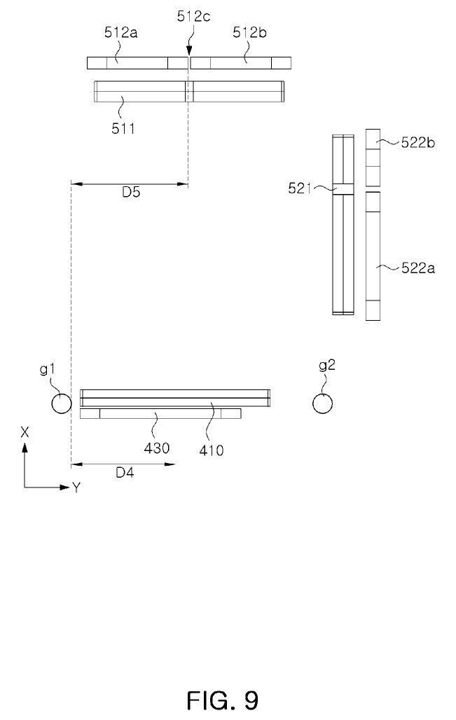

Referring to FIG. 9, a distance D4 in the second axis (Y-axis) direction between the center of the AF magnet 410 and the first support guide g1 may be different from a distance D5 in the second axis (Y-axis) direction between the separation space 512c between the first sub-coil 512a and the second sub-coil 512b of the first OIS coil portion 512 and the first support guide g1.

For example, the distance D4 in the second axis (Y-axis) direction between the center of the AF magnet 410 and the first support guide g1 may be smaller than the distance D5 in the second axis (Y-axis) direction between the separation space 512c between the first sub-coil 512a and the second sub-coil 512b of the first OIS coil portion 512 and the first support guide g1. That is, the center of the AF magnet 410 may be disposed closer to the first support guide g1 than the separation space 512c. Accordingly, the operational stability during the focus adjustment may be improved by disposing the AF magnet 410 closer to the first support guide g1.

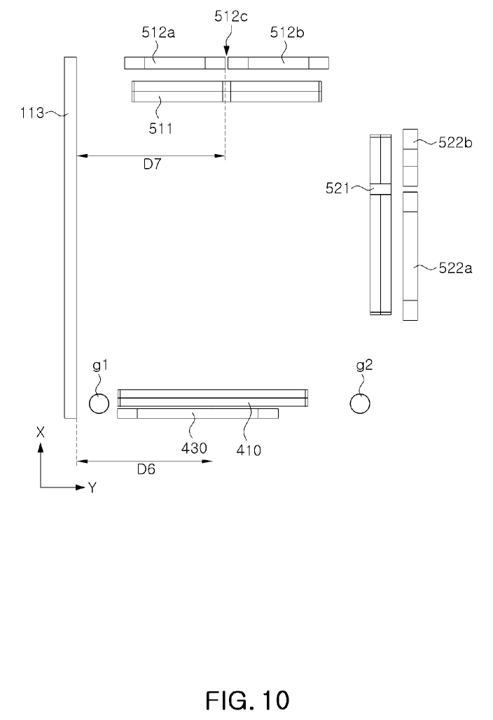

Referring to FIG. 10, a distance D6 in the second axis (Y-axis) direction between the center of the AF magnet 410 and the third side surface 113 of the housing 110 may be different from a distance D7 in the second axis (Y-axis) direction between the separation space 512c between the first sub-coil 512a and the second sub-coil 512b of the first OIS coil portion 512 and the third side surface 113 of the housing 110.

For example, the distance D6 in the second axis (Y-axis) direction between the center of the AF magnet 410 and the third side surface 113 of the housing 110 may be smaller than the distance D7 in the second axis (Y-axis) direction between the separation space 512c between the first sub-coil 512a and the second sub-coil 512b of the first OIS coil portion 512 and the third side surface 113 of the housing 110. That is, the center of the AF magnet 410 may be disposed closer to the third side surface 113 of the housing 110 than the separation space 512c.

Here, a third side surface 113 of the housing 110 may mean a surface of the housing 110 closer to the AF magnet 410 among side surfaces of the housing 110 perpendicular to the AF magnet 410.

Alternatively, the third side surface of the housing 110 may mean a side surface of the housing 110 opposite to a side surface of the housing 110 on which the second image stabilization actuator 520 is disposed. Alternatively, the third side surface 113 of the housing 110 may mean a side surface of the housing 110 on which no coil is disposed.

A ratio of a length of the first OIS magnet 511 in the second axis (Y-axis) direction to a length of the AF magnet 410 in the second axis (Y-axis) direction is greater than or equal to 0.5 and less than or equal to 1.

When viewed in the first axis (X-axis) direction, the center of the AF magnet 410 and a center of a lens barrel 220 may be spaced apart from each other in the second axis (Y-axis) direction.

When viewed in the optical axis (Z-axis) direction, the center of the AF magnet 410 may be disposed at a position spaced apart from a center of the imaging surface of the image sensor 710 in the first axis (X-axis) direction and the second axis (Y-axis) direction.

The second image stabilization actuator 520 includes the second OIS magnet 521 and a second OIS coil portion 522. The second OIS magnet 521 and the second OIS coil portion 522 may be disposed to face each other in the second axis (Y-axis) direction.

One of the second OIS magnet 521 and the second OIS coil portion 522 may be disposed on the OIS carrier 330, and the other one of the second OIS magnet 521 and the second OIS coil portion 522 may be disposed on the housing 110. Hereinafter, a description will be given based on an embodiment in which the second OIS magnet 521 is disposed on the OIS carrier 330.

The second OIS magnet 521 may be disposed on the OIS carrier 330. For example, the second OIS magnet 521 may be mounted on another side surface of the OIS carrier 330 on which the AF magnet 410 and the first OIS magnet 521 are not mounted.

The side surface of the carrier 330 on which the first OIS magnet 521 is mounted and the other side surface of the OIS carrier 330 on which the second OIS magnet 522 is mounted may be perpendicular to each other.

The second OIS magnet 521 may be magnetized so that one surface thereof has both an S-pole and an N-pole. As an example, the S-pole, a neutral region, and the N-pole may be sequentially provided on one surface of the second OIS magnet 521 along the first axis (X-axis) direction. The second OIS magnet 521 has a shape having a length in the first axis (X-axis) direction.

The other surface of the second OIS magnet 521 may be magnetized to have a polarity opposite to a polarity of the one surface of the second OIS magnet 521.

The second OIS coil portion 522 is disposed to face the second OIS magnet 521. For example, the second OIS coil portion 522 may be disposed to face the second OIS magnet 521 in the second axis (Y-axis) direction.

The second OIS coil portion 522 may be disposed on the fourth side surface 114 of the housing 110. An opening is provided in the fourth side surface 114 of the housing 110.

The second OIS coil portion 522 may include two coils spaced apart from each other, and the two coils of the second OIS coil portion 522 may each have a donut shape having a hole.

In an embodiment, the second OIS coil portion 522 includes a third sub-coil 522a and a fourth sub-coil 522b. The third sub-coil 522a and the fourth sub-coil 522b are spaced apart from each other in the first axis (X-axis) direction.

One of the two coils of the second OIS coil portion 522 may be disposed to face the N-pole on the one surface of the second OIS magnet 521, and the other one of the two coils of the second OIS coil portion 522 may be disposed to face the S-pole on the one surface of the second OIS magnet 521.

For example, a polarity of the second OIS magnet 521 facing the third sub-coil 522a and a polarity of the second OIS magnet 521 facing the fourth sub-coil 522b may be different from each other.

Due to the polarity arrangement of the second OIS magnet 521 and the arrangement of the second OIS coil portion 512, a magnetic field leakage may be prevented, and thus a sufficient driving force may be generated even with a low power.

In the present embodiment, the second OIS magnet 521 is configured as a single magnet, but the second OIS magnet 521 may also be configured to include a plurality of magnets. In this case, one surface of each of the plurality of magnets may be configured to have one polarity.

The first OIS coil portion 512 and the second OIS coil portion 522 may be disposed on the substrate 140. For example, the first OIS coil portion 512 and the second OIS coil portion 522 may be disposed on the substrate 140 so as to face the first OIS magnet 511 and the second OIS magnet 521.

The substrate 140 is mounted on the side surface of the housing 110, and the first OIS coil portion 512 and the second OIS coil portion 522 may directly face the first OIS magnet 511 and the second OIS magnet 521 through respective openings provided in the housing 110.

During the image stabilization, the second OIS magnet 521 is a moving member mounted on the OIS carrier 330, and the second OIS coil portion 522 is a fixed member fixed to the housing 110.

The second OIS magnet 521 and the second OIS coil portion 522 may generate a driving force in the direction (for example, the second axis (Y-axis) direction) in which the second OIS magnet 521 and the second OIS coil portion 522 face each other.

When power is applied to the second OIS coil portion 522, the lens module 200 and the OIS carrier 330 may be moved in the second axis (Y-axis) direction by an electromagnetic force generated between the second OIS magnet 521 and the second OIS coil portion 522.

The first OIS magnet 511 and the second OIS magnet 521 are disposed perpendicular to each other on a plane perpendicular to the optical axis (Z-axis) direction, and the first OIS coil portion 512 and the second OIS coil portion 522 are also disposed perpendicular to each other on the plane perpendicular to the optical axis (Z-axis) direction.

A second guide unit G2 is disposed between the OIS carrier 330 and the AF carrier 300.

In an embodiment, the second guide unit G2 may include a plurality of balls. The plurality of balls may roll in the direction perpendicular to the optical axis (Z-axis) direction when the OIS carrier 330 moves in the direction perpendicular to the optical axis (Z-axis) direction.

The second guide unit G2 includes three or more balls.

A second yoke 514 and a third yoke 524 are disposed on the AF carrier 300. The second yoke 514 and the third yoke 524 are disposed to face the first OIS magnet 511 and the second OIS magnet 521 in the optical axis (Z-axis) direction.

Accordingly, an attractive force is generated in the optical axis (Z-axis) direction between the second yoke 514 and the first OIS magnet 511, and an attractive force is generated in the optical axis (Z-axis) direction between the third yoke 524 and the second OIS magnet 521.

Accordingly, the OIS carrier 330 and the AF carrier 300 may be held in contact with the second guide unit G2 by the attractive force generated between the second yoke 514 and the first OIS magnet 511 and the attractive force generated between the third yoke 524 and the second OIS magnet 521.

The second yoke 514 and the third yoke 524 may each be a magnetic body.

A second guide groove gr2 may be formed in either one or both of the OIS carrier 330 and the AF carrier 300.

For example, the second guide groove gr2 may be formed in either one or both of a surface of the OIS carrier 330 and a surface of the AF carrier 300 facing each other.

A plurality of second guide grooves gr2 are formed to correspond to the plurality of balls of the second guide unit G2.

The second guide unit G2 is accommodated in the second guide grooves gr2 and is interposed between the OIS carrier 330 and the AF carrier 300.

A size of the second guide grooves gr2 is greater than a diameter of each of the plurality of balls of the second guide unit G2. For example, a planar shape of the second guide grooves gr2 may be circular or polygonal.

In an embodiment, the camera module 1 may detect a position of the OIS carrier 330 in the direction perpendicular to the optical axis (Z-axis) direction.

For this purpose, a first position sensor 513 and a second position sensor 523 are provided. The first position sensor 513 may be disposed on the substrate 140 to face the first OIS magnet 511, and the second position sensor 523 may be disposed on the substrate 140 to face the second OIS magnet 521. The first position sensor 513 and the second position sensor 523 may be Hall sensors.

Either one or both of the first position sensor 513 and the second position sensor 523 may include two Hall sensors.

For example, the first position sensor 513 may include two Hall sensors disposed to face the first OIS magnet 511. One of the two Hall sensors may be disposed in a hole of the first sub-coil 512a, and the other one of the two Hall sensors may be disposed in a hole of the second sub-coil 512b.

Through the two Hall sensors facing the first OIS magnet 511, it is possible to detect whether the OIS carrier 330 is rotated.

Since the second OIS coil portion 512 includes two coils facing the first OIS magnet 511, the second OIS coil portion 512 may be controlled to offset a rotational force applied to the OIS carrier 330.

Referring to FIG. 7, one surface of the second OIS magnet 521 may have a first polarity 521a and a second polarity 521b spaced apart from each other in the first axis (X-axis) direction. The first polarity 521a may be an N-pole or an S-pole, and the second polarity 521b may have a polarity opposite to the polarity of the first polarity 521a.

An area of the first polarity 521a may be different from an area of the second polarity 521b. For example, the area of the first polarity 521a may be larger than the area of the second polarity 521b.

A length of the first polarity 521a in the first axis (X-axis) direction and a length of the second polarity 521b in the first axis (X-axis) direction may be different. For example, the length of the first polarity 521a in the first axis (X-axis) direction may be greater than the length of the second polarity 521b in the first axis (X-axis) direction.

The third sub-coil 522a of the second OIS coil portion 522 may be disposed to face the first polarity 521a of the second OIS magnet 521, and the fourth sub-coil 522b of the second OIS coil portion 522 may be disposed to face the second polarity 521b of the second OIS magnet 521.

A length of the third sub-coil 522a in the first axis (X-axis) direction and a length of the fourth sub-coil 522b in the first axis (X-axis) direction may be different. For example, the length of the third sub-coil 522a in the first axis (X-axis) direction may be greater than the length of the fourth sub-coil 522b in the first axis (X-axis) direction.

The second position sensor 523 may be disposed at a position spaced apart from a center of the third sub-coil 522a. For example, the second position sensor 523 may be disposed at a position spaced apart from the center of the third sub-coil 522a in the first axis (X-axis) direction.

A position of the second position sensor 523 in the first axis (X-axis) direction may be disposed between a center of the third sub-coil 522a and a center of the fourth sub-coil 522b. That is, the second position sensor 523 may be disposed between the center of the third sub-coil 522a and the center of the fourth sub-coil 522b.

The second position sensor 523 may be disposed to face one of the first polarity 521a and the second polarity 521b of the second OIS magnet 521. For example, the second position sensor 523 may be disposed to face a polarity having a greater length (or a larger area) among the first polarity 521a and the second polarity 521b of the second OIS magnet 521.

In an embodiment, the second position sensor 523 may be disposed to face the first polarity 521a of the second OIS magnet 521.

Furthermore, the second position sensor 523 may be disposed to be spaced apart from a center C1 of the first polarity 521a of the second OIS magnet 521. Accordingly, the second position sensor 523 may face a portion of the second OIS magnet 521 spaced apart from the center C1 of the first polarity 521a in the first axis (X-axis) direction.

In an embodiment, a center of the second position sensor 523 may be disposed to be spaced apart from the center C1 of the first polarity 521a of the second OIS magnet 521 in the first axis (X-axis) direction. Here, a direction in which the center of the second position sensor 523 is spaced apart from the center C1 of the first polarity 521a of the second OIS magnet 521 in the first axis (X-axis) direction may be a direction toward the second polarity 521b of the second OIS magnet 521.

For example, the second position sensor 523 may face the first polarity 521a of the second OIS magnet 521, and the center of the second position sensor 523 may be disposed between the center C1 of the first polarity 521a of the second OIS magnet 521 and a center C2 of the second polarity 521b of the second OIS magnet 521.

In an embodiment, the second position sensor 523 may be disposed to face a center C3 of the OIS carrier 330. For example, when viewed in the second axis (Y-axis) direction, the center C3 in the first axis (X-axis) direction of one side surface of the OIS carrier 330 on which the second OIS magnet 521 is disposed may overlap with the second position sensor 523.

During the image stabilization, the OIS carrier 330 may move along the first axis (X-axis) direction and the second axis (Y-axis) direction while being supported by the second guide unit G2.

In this case, since the plurality of balls of the second guide unit G2 are capable of rolling in various directions perpendicular to the optical axis (Z-axis) direction, the OIS carrier 330 may rotate due to various unintended factors such as a deviation between a driving force of the first image stabilization actuator 510 and a driving force of the second image stabilization actuator 520.

In this case, an error may occur in a position of the OIS carrier 330 detected by the second position sensor 523.

In the camera module 1 according to an embodiment in the present disclosure, a length of the third sub-coil 522a is made to be greater than a length of the fourth sub-coil 522b, and the second position sensor 523 is disposed at a position spaced apart from the center of the third sub-coil 522a.

Furthermore, the second position sensor 523 is disposed to face a polarity having a greater length (for example, the first polarity 521a) on one surface of the second OIS magnet 521, and the second position sensor 523 is disposed to be biased toward the second polarity 521b from the center of the first polarity 521a.

Accordingly, the second position sensor 523 may be disposed closer to a center of the OIS carrier 330 (preferably, the second position sensor 523 is disposed to face the center of the OIS carrier 330). Therefore, even if the unintended rotation occurs in the OIS carrier 330, it is possible to prevent an error from occurring in the position of the OIS carrier 330 (the position in the second axis (Y-axis) direction)) detected by the second position sensor 523.

That is, even when the OIS carrier 330 rotates, a distance between the second OIS magnet 521 and the second position sensor 523 may remain unchanged, or even if it changes, the amount of change may be very small.

Accordingly, the position of the OIS carrier 330 detected by the second position sensor 523 may not be affected by the rotation of the OIS carrier 330.

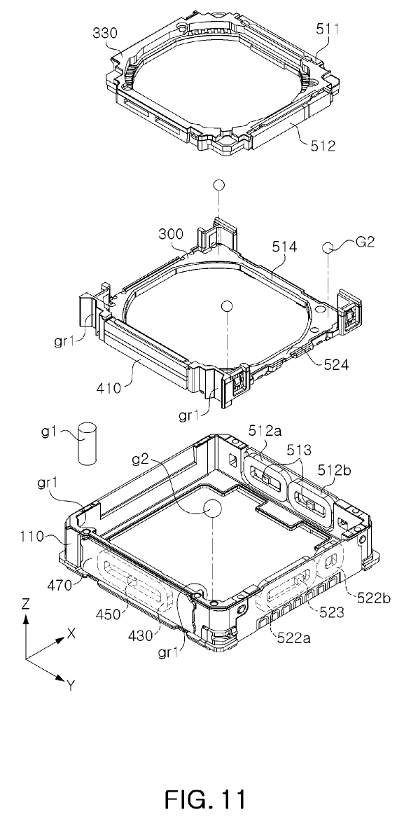

FIG. 11 is an exploded perspective view of the housing, the AF carrier, and the OIS carrier of FIG. 2 with a modified example of a first guide unit.

Referring to FIG. 11, the first support guide g1 may have a shaft shape having a length in the optical axis (Z-axis) direction.

For example, the first support guide g1 may have a cylindrical or semi-cylindrical shape extending in the optical axis (Z-axis) direction.

The shaft-shaped first support guide g1 may be fixed to one of the AF carrier 300 and the housing 110.

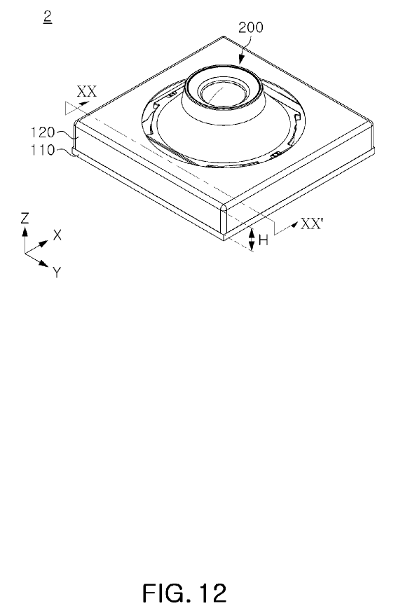

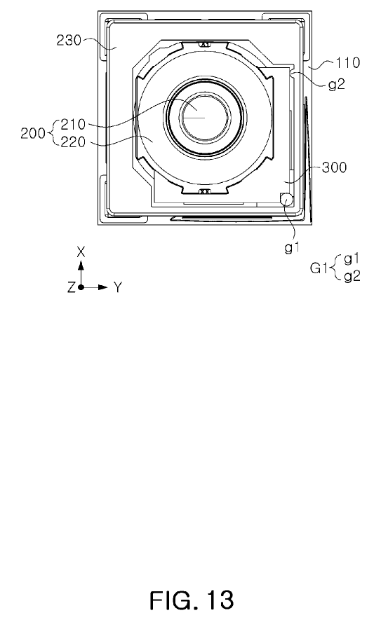

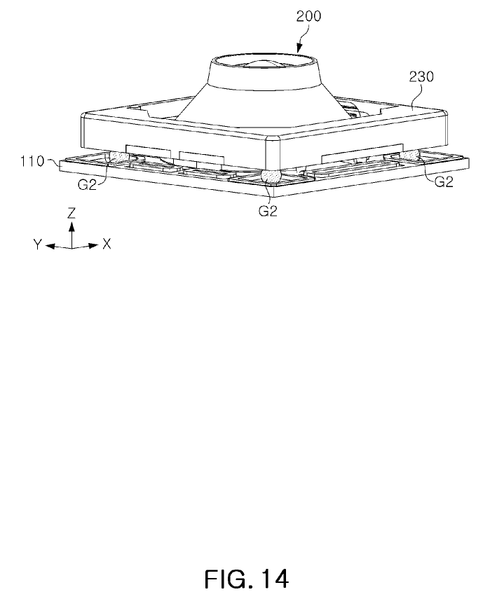

FIG. 12 is a perspective view of a camera module according to another embodiment in the present disclosure, FIG. 13 is a plan view of the camera module of FIG. 12 with a case removed, and FIG. 14 is a perspective view of the camera module of FIG. 12 with the case removed.

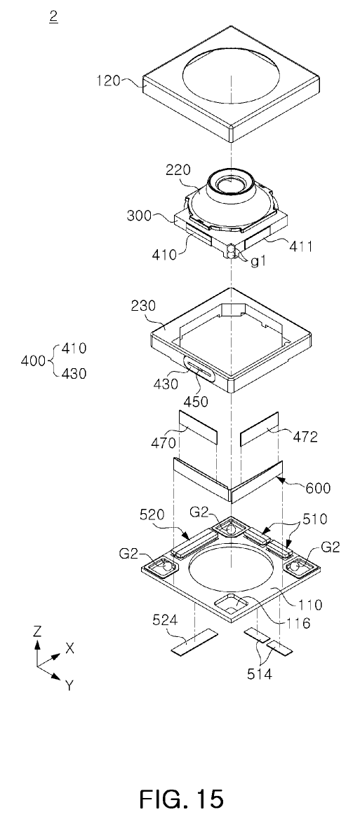

FIG. 15 is an exploded perspective view of the camera module of FIG. 12.

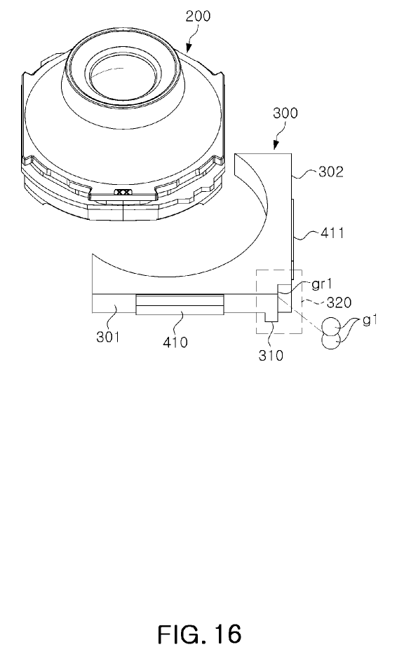

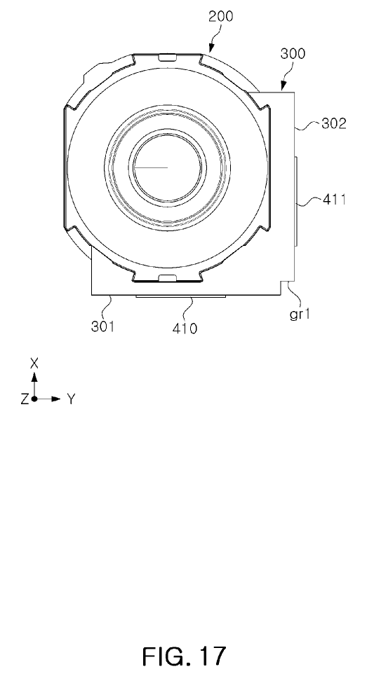

FIG. 16 is an exploded perspective view of a lens module and an AF carrier of FIG. 15, and FIG. 17 is a plan view of the lens module and the AF carrier of FIG. 15.

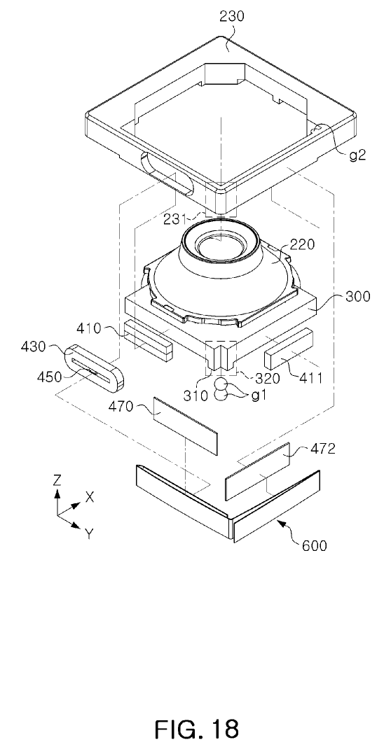

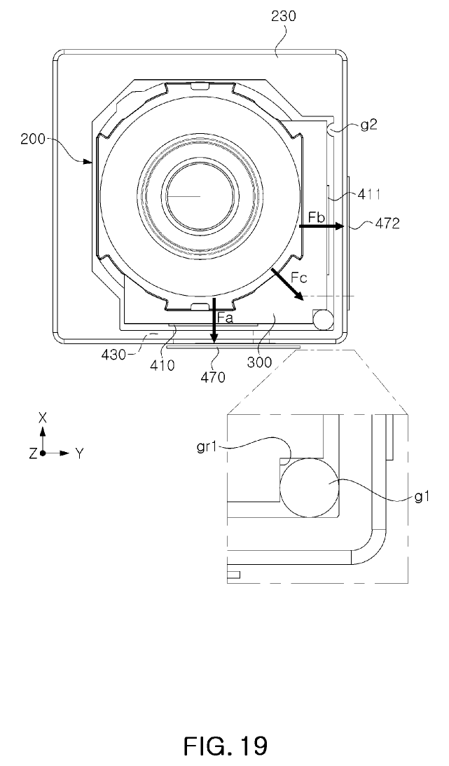

FIG. 18 is an exploded perspective view of the lens module, the AF carrier, an OIS carrier, and a first actuator of FIG. 15, and FIG. 19 is a plan view of the lens module, the AF carrier, the OIS carrier, and the first actuator of FIG. 15.

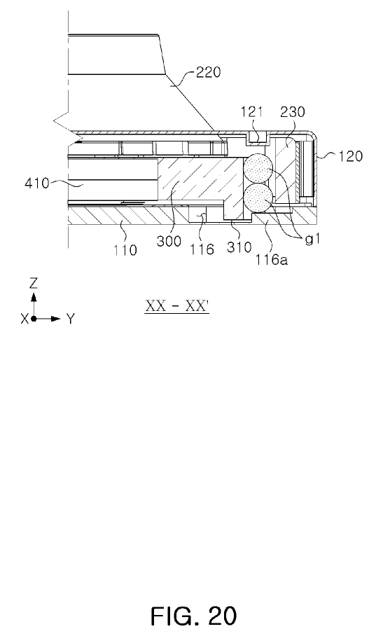

FIG. 20 is a cross-sectional view taken along line XX-XX' of FIG. 12.

Referring to FIGS. 12-15, the camera module 2 according to another embodiment in the present disclosure includes an optical module and a housing 110.

The optical module may be understood to include either one or both of a lens module 200 and an image sensor module 700. For example, in an embodiment, the optical module may mean a lens module 200, and in another embodiment, the optical module may mean an image sensor module 700.

The camera module 2 may further include the AF carrier 300. In this case, the lens barrel 220 may be coupled to the AF carrier 300.

The AF carrier 300 may move in the optical axis (Z-axis) direction relative to the housing 110. Since the lens barrel 220 is coupled to the AF carrier 300, the lens barrel 220 may move in the optical axis (Z-axis) direction together with the AF carrier 300.

That is, a distance between the lens module 200 and an image sensor 710 may be changed to adjust a focus.

The camera module 2 may further include an OIS carrier 230. The OIS carrier 230 is disposed in the housing 110 and may move relative to the housing 110 in a direction perpendicular to the optical axis (Z-axis). The lens module 200 and the AF carrier 300 may be disposed in the OIS carrier 230. Accordingly, the lens module 200, the AF carrier 300, and the OIS carrier 230 may move together in the direction perpendicular to the optical axis (Z-axis).

That is, the lens module 200, the AF carrier 300, and the OIS carrier 230 may move in the direction perpendicular to the optical axis (Z-axis) direction to perform image stabilization during image capture.

The housing 110 may have a plate shape. However, the present disclosure is not limited thereto, and the housing 110 may also be provided in a box shape having an open upper portion and an open lower portion as in the embodiment described with reference to FIGS. 1-11.

The OIS carrier 230 may be disposed in the housing 110, and the lens module 200 and the AF carrier 300 may be accommodated in the OIS carrier 230.

The case 120 is coupled to the housing 110 so as to surround an outer surface of the housing 110 and functions to protect internal components of the camera module 2.

Although not illustrated in the drawings, the camera module 2 includes the image sensor module 700 as in the embodiment described with reference to FIGS. 1-11.

The image sensor module 700 is disposed under the housing 110.

The camera module 2 may further include a stopper 130 of the embodiment described with reference to FIGS. 1-11. The stopper 130 is coupled to the OIS carrier 230 so as to cover at least a portion of an upper surface of the AF carrier 300.

The camera module 2 may include a first actuator 400. The lens module 200 may be moved in the optical axis (Z-axis) direction by the first actuator 400.

For example, the first actuator 400 may generate a driving force in the optical axis (Z-axis) direction to move the AF carrier 300. Since the lens module 200 is coupled to the AF carrier 300, the AF carrier 300 and the lens module 200 may be moved together in the optical axis (Z-axis) direction by the driving force of the first actuator 400.

The first actuator 400 includes an AF magnet 410 and an AF coil 430. The AF magnet 410 and the AF coil 430 may be disposed to face each other in the direction perpendicular to the optical axis (Z-axis) direction. For example, the AF magnet 410 and the AF coil 430 may face each other in the first axis (X-axis) direction.

One of the AF magnet 410 and the AF coil 430 may be disposed on the AF carrier 300, and the other one of the AF magnet 410 and the AF coil 430 may be disposed on the housing 110. Hereinafter, a description will be given based on an embodiment in which the AF magnet 410 is disposed on the AF carrier 300.

The AF magnet 410 is mounted on the AF carrier 300. As an example, the AF magnet 410 may be mounted on one side surface 301 of the AF carrier 300.

The AF magnet 410 may be magnetized so that one surface (for example, the surface facing the AF coil 430) of the AF magnet 410 has both an N-pole and an S-pole. As an example, an N-pole, a neutral region, and an S-pole may be sequentially provided on one surface of the AF magnet 410 facing the AF coil 430 in the optical axis (Z-axis) direction.

In the present specification, a first polarity may mean an N-pole or an S-pole, and a second polarity may mean a polarity opposite to the first polarity.

The AF coil 430 is disposed to face the AF magnet 410. For example, the AF coil 430 may be disposed to face the AF magnet 410 in the direction perpendicular to the optical axis (Z-axis) direction.

The AF coil 430 is disposed on a connection substrate 600, and a portion of the connection substrate 600 is mounted on the OIS carrier 230 so that the AF magnet 410 and the AF coil 430 face each other in the direction perpendicular to the optical axis (Z-axis) direction.

During the focus adjustment, the AF magnet 410 is a moving member mounted on the AF carrier 300 and moving together with the AF carrier 300 in the optical axis (Z-axis) direction, and the AF coil 430 is a fixed member fixed to the connection substrate 600. For reference, the AF coil 430 may be a moving member during image stabilization.

When power is applied to the AF coil 430, the AF carrier 300 may be moved in the optical axis (Z-axis) direction by an electromagnetic force generated between the AF magnet 410 and the AF coil 430.

Since the lens module 200 is coupled to the AF carrier 300, the lens module 200 is also moved in the optical axis (Z-axis) direction by the movement of the AF carrier 300.

A first guide unit G1 is disposed between the AF carrier 300 and the OIS carrier 230. The first guide unit G1 may guide the movement of the AF carrier 300.

The first guide unit G1 includes a first support guide g1 and a second support guide g2 spaced apart from each other in the direction perpendicular to the optical axis (Z-axis) direction.

In an embodiment, the first guide unit G1 may include a plurality of balls. The plurality of balls may roll in the optical axis (Z-axis) direction when the AF carrier 300 moves in the optical axis (Z-axis) direction.

For example, the first support guide g1 may include the plurality of balls.

In another embodiment, the first support guide g1 may have a shaft shape having a length in the optical axis (Z-axis) direction (see FIG. 11). For example, the first support guide g1 may have a cylindrical or semi-cylindrical shape extending in the optical axis (Z-axis) direction.

The shaft-shaped first support guide g1 may be fixed to either the AF carrier 300 or the OIS carrier 230.

Furthermore, the second support guide g2 may include a protrusion protruding from either one or both of the AF carrier 300 and the OIS carrier 230. A surface of the protrusion may have a curved surface. For example, the protrusion may have a hemispherical shape. Alternatively, the second support guide g2 may be configured to include one or more balls.

The first support guide g1 may function as a main guide guiding the movement of the lens module 200 in the optical axis (Z-axis) direction.

The second support guide g2 may function as an auxiliary guide supporting the movement of the lens module 200 in the optical axis (Z-axis) direction.

A position of the second support guide g2 in the optical axis (Z-axis) direction may be between opposite ends of the first support guide g1 in the optical axis (Z-axis) direction.

A first yoke 470 is disposed on the OIS carrier 230. The first yoke 470 may be disposed at a position spaced apart from the AF magnet 410 in the first axis (X-axis) direction. The first yoke 470 may be disposed on the connection substrate 600.

The AF magnet 410 and the first yoke 470 may generate an attractive force therebetween. For example, the first yoke 470 may be made of a magnetic material. The attractive force acts between the AF magnet 410 and the first yoke 470 in the direction (for example, the first axis (X-axis) direction) perpendicular to the optical axis (Z-axis) direction.

A first guide groove gr1 may be formed in either one or both of the AF carrier 300 and the OIS carrier 230.

For example, the first guide groove gr1 may be formed in either one both of a surface of the AF carrier 300 and a surface of the OIS carrier 230 facing each other.

The first guide groove gr1 extends in the optical axis (Z-axis) direction. The first support guide g1 is disposed in the first guide groove gr1.

The first support guide g1 and the second support guide g2 are spaced apart from each other in the direction (for example, the first axis (X-axis direction) perpendicular to the optical axis (Z-axis) direction. The first support guide g1 includes the plurality of balls disposed in the optical axis (Z-axis) direction. The second support guide g2 includes a number of protrusions (or balls) smaller than the number of balls included in the first support guide g1.

For example, the first support guide g1 includes two or more balls disposed in the optical axis (Z-axis) direction, and the second support guide g2 includes a smaller number of protrusions (or balls) than the number of balls included in the first support guide g1.

The first support guide g1 may be disposed in a corner region of the camera module 2. The corner region may refer to a portion where two surfaces perpendicular to each other meet. However, in the present specification, the corner region is not limited to a point geometrically defined as a corner, but may refer to a region within a predetermined range including a portion (or a surrounding portion) adjacent to the corner.

According to an embodiment in the present disclosure, the camera module 2 may have a rectangular shape having four corner regions when viewed in the optical axis (Z-axis) direction. The first support guide g1 may be disposed in one of the four corner regions.

Referring to FIG. 16, the AF carrier 300 includes one side surface 301 and another side surface 302. The one side surface 301 and the other side surface 302 may be surfaces perpendicular to each other.

The AF carrier 300 includes a first corner portion 320 at a portion where the one side surface 301 and the other side surface 302 meet, and the first guide groove gr1 in which the first support guide g1 is disposed may be formed in the first corner portion 320.

The AF carrier 300 may have a shape in which a protrusion extends in the optical axis (Z-axis) direction below a bottom surface of the AF carrier 300 at the first corner portion 320. That is, the first corner portion 320 of the AF carrier 300 has a greater length in the optical axis (Z-axis) direction than other portions of the AF carrier 300. Hereinafter, the protrusion is defined as an extension portion 310.

Referring to FIGS. 15 and 20, an accommodating portion 116 may be formed in a bottom surface of the housing 110. The accommodating portion 116 may be disposed at a position facing the extension portion 310 in the optical axis (Z-axis) direction.

The accommodating portion 116 may have a groove shape concavely formed in the bottom surface of the housing 110 or a hole shape penetrating the bottom surface of the housing 110.

A support portion 116a may be formed in the bottom surface of the housing 110 adjacent to the accommodating portion 116 to prevent the first support guide g1 from being separated from the first guide groove gr1. A height of the support portion 116a in the optical axis (Z-axis) direction may be smaller than a height of the bottom surface of the housing 110 in the optical axis (Z-axis) direction.

A protrusion portion 121 protruding toward the first support guide g1 may be formed in the case 120. The protrusion portion 121 may be a portion protruding downward in the optical axis (Z-axis) direction from one surface of the case 120. The protrusion portion 121 may face the first support guide g1 in the optical axis (Z-axis) direction to prevent the first support guide g1 from being separated from the first guide groove gr1.

A portion of the first guide groove g1 may be formed in extension portion 310. Accordingly, the first guide groove gr1 may have a sufficient length in the optical axis (Z-axis) direction, and two balls included in the first support guide g1 may be stacked and disposed in the first guide groove gr1 in the optical axis (Z-axis) direction.

In an embodiment, the second support guide g2 may refer to a protrusion protruding from an inner side surface of the OIS carrier 230 toward the other side surface 302 of the AF carrier 300.

The second support guide g2 may be in contact with the other side surface 302 of the AF carrier 300.

In an embodiment, the second support guide g2 may have a length in the optical axis (Z-axis) direction. For example, the second support guide g2 may be provided as a shaft having a hemispherical cross-section when cut in the direction perpendicular to the optical axis (Z-axis) direction.

Alternatively, in another embodiment, the second support guide g2 be a plurality of protrusions disposed in the optical axis (Z-axis) direction.

The camera module 2 may further include a first magnetic body 411 and a second magnetic body 472.

In an embodiment, one of the first magnetic body 411 and the second magnetic body 472 may be a magnet and the other one of the first magnetic body 411 and the second magnetic body 472 may be a yoke. In another embodiment, both the first magnetic body 411 and the second magnetic body 472 may be magnets.

Hereinafter, an embodiment will be described in which the first magnetic body 411 mounted on the other side surface 302 of the AF carrier 300 is a magnet and the second magnetic body 472 is a yoke.

The first magnetic body 411 may be disposed on the other side surface 302 of the AF carrier 300.

The second magnetic body 472 may be disposed to face the first magnetic body 411 in the direction (for example, in the second axis (Y-axis) direction) perpendicular to the optical axis (Z-axis) direction. In an embodiment, the second magnetic body 472 may be disposed on the OIS carrier 230.

An attractive force may act between the first magnetic body 411 and the second magnetic body 472.

Referring to FIG. 19, a first attractive force Fa acts between the AF magnet 410 and the first yoke 470 in the first axis (X-axis) direction, and a second attractive force Fb acts between the first magnetic body 411 and the second magnetic body 472 in the second axis (Y-axis) direction.

Accordingly, a direction of the first attractive force Fa acting between the AF magnet 410 and the first yoke 470 and a direction of the second attractive force Fb acting between the first magnetic body 411 and the second magnetic body 472 may be perpendicular to each other.

A resultant force Fc of the first attractive force Fa and the second attractive force Fb acts in a diagonal direction as shown in FIG. 19, and a direction of the resultant force Fc may be toward the first support guide g1.

Accordingly, the first support guide g1 may stably support the AF carrier 300.

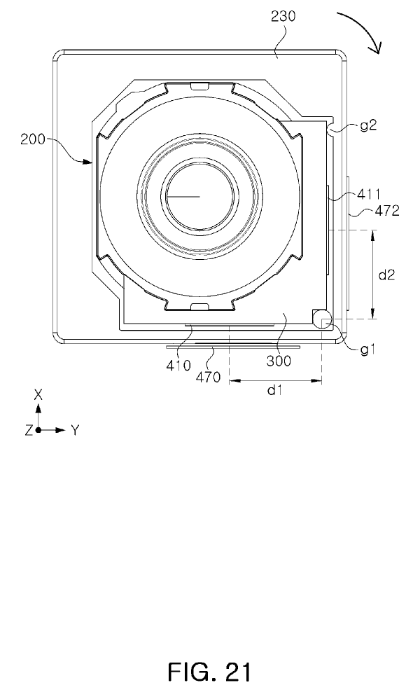

FIG. 21 is a diagram illustrating a rotational moment generated in the camera module of FIG. 12.

The AF magnet 410 and the first magnetic body 411 may be disposed at different distances from the first support guide g1, and accordingly an uneven rotational moment may act on the first support guide g1.

In an embodiment, a distance between the AF magnet 410 and the first support guide g1 may be smaller than a distance between the first magnetic body 411 and the first support guide g1. That is, the AF magnet 410 may be disposed closer to the first support guide g1, which is the main guide, than the first magnetic body 411.

Referring to FIG. 21, a first distance d1 between a center of the AF magnet 410 and a center of the first support guide g1 may be shorter than a second distance d2 between a center of the first magnetic body 411 and a center of the first support guide g1. Such an arrangement assumes that the sizes of the AF magnet 410 and the first magnetic body 411 are the same and that the sizes of the first yoke 470 and the second magnetic body 472 are the same.

Since the first attractive force Fa and the second attractive force Fb act at positions spaced apart from the first support guide g1, a rotational moment may be applied to the first support guide g1 by the first attractive force Fa and the second attractive force Fb. In this case, assuming that the magnitudes of the first attractive force Fa and the second attractive force Fb are approximately the same, when the second distance d2 is greater than the first distance d1, the rotational moment generated by the second attractive force Fb may act more strongly on the first support guide g1 than the rotational moment generated by the first attractive force Fa.

Accordingly, AF carrier 300 and the lens module 200 may rotate clockwise as shown in FIG. 21.

Since the AF carrier 300 is supported by the second support guide g2, the AF carrier 300 and the lens module 200 may eventually move in the optical axis (Z-axis) direction while being supported by the first support guide g1 and the second support guide g2.

In another embodiment, the first AF magnet 410 and the first magnetic body 411 may be disposed so that the first distance d1 between the center of the AF magnet 410 and the center of the first support guide g1 may be the same as the second distance d2 between the center of the first magnetic body 411 and the center of the first support guide g1, and an uneven rotational moment may be induced by making sizes of the AF magnet 410 and the first magnetic body 411 and/or sizes of the first yoke 470 and the second magnetic body 472 different from each other.

Furthermore, a position of the second support guide g2 may be changed depending on a rotation direction of the AF carrier 300 and the lens module 200 so that the AF carrier 300 is pressed against the second support guide g2 as the AF carrier 300 and the lens module 200 rotate.

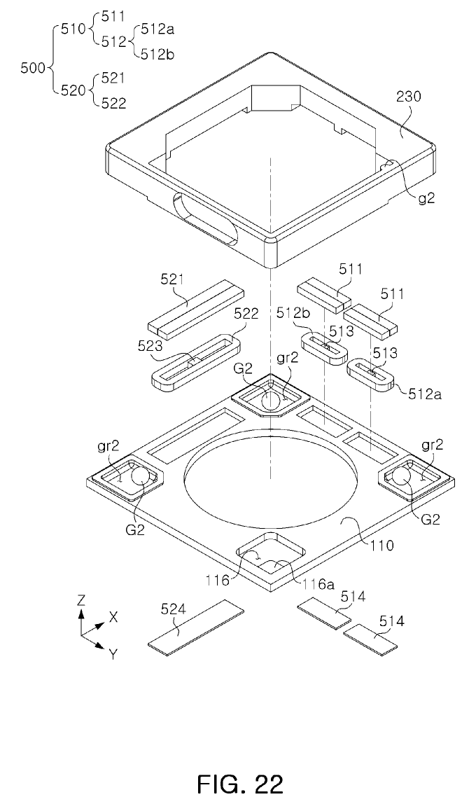

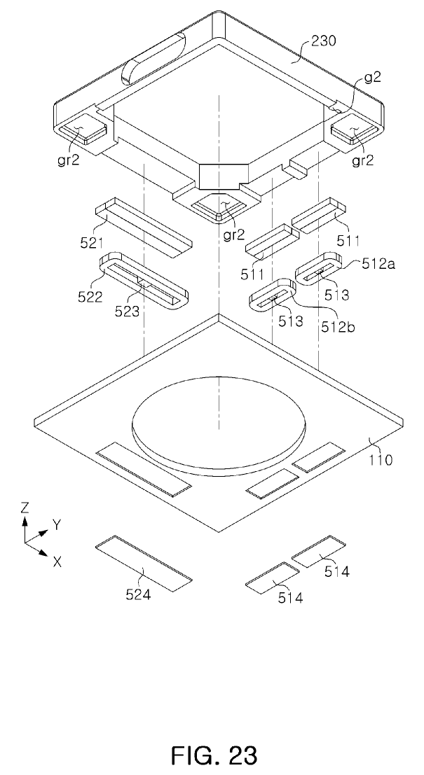

FIG. 22 is an exploded perspective view of a housing, the OIS carrier, and a second actuator of FIG. 15., and FIG. 23 is a bottom exploded perspective view of the housing, the OIS carrier, and the second actuator of FIG. 15.

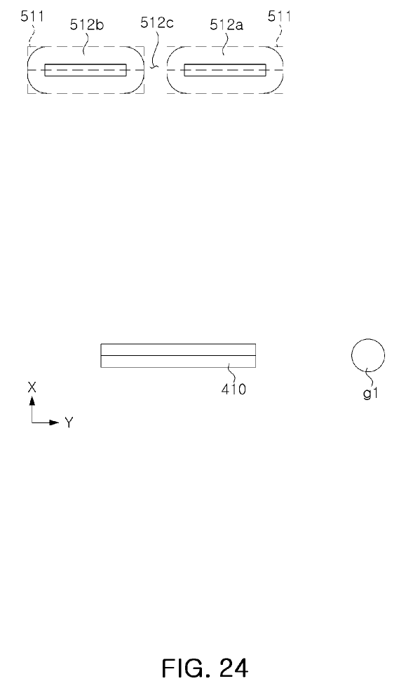

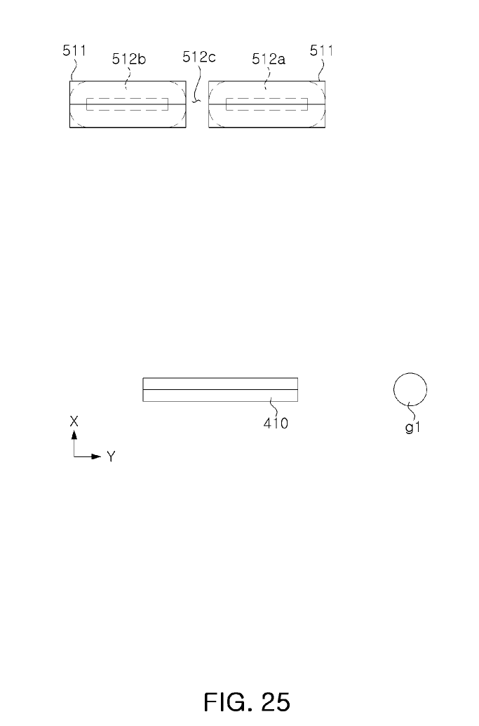

FIGS. 24 and 25 are plan views of the first actuator and a first image stabilization actuator of FIG. 15.

In an embodiment, the camera module 2 may detect a position of the AF carrier 300 in the optical axis (Z-axis) direction.

For this purpose, a first position sensor 450 is provided. The first position sensor 450 is disposed on the connection substrate 600 to face the AF magnet 410. The first position sensor 450 may be a Hall sensor.

Referring to FIG. 22, the camera module 2 may perform the image stabilization during image capture by moving the lens module 200 in the direction perpendicular to the optical axis (Z-axis) direction. For this purpose, the camera module 2 includes a second actuator 500 moving the lens module 200 in the direction perpendicular to the optical axis (Z-axis) direction.

By the driving force of the second actuator 500, the lens module 200, the AF carrier 300, and the OIS carrier 230 may move together in the direction perpendicular to the optical axis (Z-axis) direction.

For example, the lens module 200, the AF carrier 300, and the OIS carrier 230 may move together in the first axis (X-axis) direction and the second axis (Y-axis) direction.

The second actuator 500 includes a first image stabilization actuator 510 and a second image stabilization actuator 520. The first image stabilization actuator 510 may generate the driving force in the first axis (X-axis) direction, and the second image stabilization actuator 520 may generate the driving force in the second axis (Y-axis) direction.

The first image stabilization actuator 510 includes a first OIS magnet 511 and a first OIS coil portion 512. The first OIS magnet 511 and the first OIS coil portion 512 may be disposed to face each other in the optical axis (Z-axis) direction.

One of the first OIS magnet 511 and the first OIS coil portion 512 may be disposed on the OIS carrier 230, and the other one of the first OIS magnet 511 and the first OIS coil portion 512 may be disposed on the housing 110. Hereinafter, a description will be given based on an embodiment in which the first OIS magnet 511 is disposed on the OIS carrier 230.

The first OIS magnet 511 may be disposed on the OIS carrier 230. For example, the first OIS magnet 511 may be mounted on a lower surface of the OIS carrier 230.

The first OIS magnet 511 may be magnetized so that one surface thereof has both an N-pole and an S-pole. As an example, the N-pole, a neutral region, and the S-pole may be sequentially provided on one surface of the first OIS magnet 511 along the first axis (X-axis) direction. The first OIS magnet 511 has a shape having a length in the second axis (Y-axis) direction.

The other surface of the first OIS magnet 511 may be magnetized to have a polarity opposite to the polarity of the one surface of the first OIS magnet 511.

The first OIS magnet 511 may include two magnets spaced apart from each other in the second axis (Y-axis) direction.

The first OIS coil portion 512 may be disposed to face the first OIS magnet 511. For example, the first OIS coil portion 512 may be disposed to face the first OIS magnet 511 in the optical axis (Z-axis) direction.

The first OIS coil portion 512 may include two coils spaced apart from each other, and the two coils of the first OIS coil portion 512 may each have a donut shape having a hole.

In an embodiment, the first OIS coil portion 512 may include a first sub-coil 512a and a second sub-coil 512b. The first sub-coil 512a and the second sub-coil 512b may be spaced apart from each other in the second axis (Y-axis) direction.

Accordingly, a separation space 512c may be formed between the first sub-coil 512a and the second sub-coil 512b in the second axis (Y-axis) direction (see FIGS. 24 and 25).

One of the two coils of the first OIS coil portion 512 may be disposed to face one of the two magnets of the first OIS magnet 511, and the other one of the two coils of the first OIS coil portion 512 may be disposed to face the other one of the two magnets of the first OIS magnet 511.

During the image stabilization, the first OIS magnet 511 is a moving member mounted on the OIS carrier 230, and the first OIS coil portion 512 is a fixed member fixed to the housing 110.

The first OIS magnet 511 and the first OIS coil portion 512 may generate a driving force in a direction (for example, the first axis (X-axis) direction) perpendicular to the direction in which the first OIS magnet 511 and the first OIS coil portion 512 face each other.

When power is applied to the first OIS coil portion 512, the OIS carrier 230, the AF carrier 300, and the lens module 200 may be moved in the first axis (X-axis) direction by an electromagnetic force generated between the first OIS magnet 511 and the first OIS coil portion 512.

When viewed in the optical axis (Z-axis) direction, the first OIS magnet 511 may be disposed at a position spaced apart from the AF magnet 410 in the first axis (X-axis) direction.

Furthermore, when viewed in the optical axis (Z-axis) direction, the two coils of the first OIS coil portion 512 may be disposed at positions spaced apart from the AF magnet 410 in the first axis (X-axis) direction. For example, the first sub-coil 512a and the second sub-coil 512b may be disposed to be spaced apart from the AF magnet 410 in the first axis (X-axis) direction.

Here, when viewed in the optical axis (Z-axis) direction, a center of the AF magnet 410 in the second axis (Y-axis) direction may be spaced apart from the separation space 512c between the two coils of the first OIS coil portion 512 in the second axis (Y-axis) direction.

A distance in the second axis (Y-axis) direction between the center of the AF magnet 410 and the first support guide g1 may be smaller than a distance in the second axis (Y-axis) direction between the separation space 512c between the first sub-coil 512a and the second sub-coil 512b and the first support guide g1.

Since the first OIS magnet 511 includes two magnets spaced apart from each other in the second axis (Y-axis) direction, a separation space may also be formed between the two magnets.

A relationship between a position in the second axis (Y-axis) direction of the center of the AF magnet 410 and a position in the second axis (Y-axis) direction of the separation space between the two magnets is the same as that described above for the separation space 512c between the first sub-coil 512a and the second sub-coil 512b.

That is, the center of the AF magnet 410 and the separation space between the two magnets of the first OIS magnet 511 may be spaced apart in the second axis (Y-axis) direction.

A distance in the second axis (Y-axis) direction between the center of the AF magnet 410 and the first support guide g1 may be smaller than a distance in the second axis (Y-axis) direction between the separation space between the two magnets of the first OIS magnet 511 and the first support guide g1.

That is, the center of the AF magnet 410 may be disposed closer to the first support guide g1 than the separation space between the two magnets of the first OIS magnet 511.

A distance in the second axis (Y-axis) direction between the center of the AF magnet 410 and one side surface of the housing 110 may be different from a distance in the second axis (Y-axis) direction between the separation space 512c between the two coils of the first OIS coil portion 512 and the one side surface of the housing 110.

For example, a distance in the second axis (Y-axis) direction between the center of the AF magnet 410 and one side surface of the housing 110 may be smaller than a distance in the second axis (Y-axis) direction between the separation space 512c between the two coils of the first OIS coil portion 512 and the one side surface of the housing 110.

Here, one side surface of the housing 110 may mean a surface closest to the AF magnet 410 among side surfaces of the housing 110 perpendicular to the AF magnet 410.

Alternatively, one side surface of the housing 110 may mean the side surface of the housing 110 opposite to a side on which the second image stabilization actuator 520 is disposed.

A ratio of a length of the first OIS magnet 511 in the second axis (Y-axis) direction to a length of the AF magnet 410 in the second axis (Y-axis) direction is greater than or equal to 0.5 and less than or equal to 1.

When viewed in the first axis (X-axis) direction, the center of the AF magnet 410 and a center of a lens barrel 220 may be spaced apart from each other in the second axis (Y-axis) direction.

When viewed in the optical axis (Z-axis) direction, the center of the AF magnet 410 may be disposed at a position spaced apart from a center of the imaging surface of the image sensor 710 in the first axis (X-axis) direction and the second axis (Y-axis) direction.

The second image stabilization actuator 520 includes a second OIS magnet 521 and a second OIS coil portion 522. The second OIS magnet 521 and the second OIS coil portion 522 may be disposed to face each other in the optical axis (Z-axis) direction.

One of the second OIS magnet 521 and the second OIS coil portion 522 may be disposed on the OIS carrier 230, and the other one of the second OIS magnet 521 and the second OIS coil portion 522 may be disposed on the housing 110. Hereinafter, a description will be given based on an embodiment in which the second OIS magnet 521 is disposed on the OIS carrier 230.

The second OIS magnet 521 may be disposed on the OIS carrier 230. For example, the second OIS magnet 521 may be mounted on the lower surface of the OIS carrier 230.

The second OIS magnet 521 may be magnetized so that one surface thereof has both a S-pole and a N-pole. As an example, the S-pole, a neutral region, and the N-pole may be sequentially provided on one surface of the second OIS magnet 521 along the second axis (Y-axis) direction. The second OIS magnet 521 has a shape having a length in the first axis (X-axis) direction.

The other surface of the second OIS magnet 521 may be magnetized to have a polarity opposite to a polarity of the one surface of the second OIS magnet 521.

The second OIS coil portion 522 is disposed to face the second OIS magnet 521. For example, the second OIS coil portion 522 may be disposed to face the second OIS magnet 521 in the optical axis (Z-axis) direction.

The coil of the second OIS coil portion 522 may have a donut shape with a hole.

The first OIS coil portion 512 and the second OIS coil portion 522 may be disposed on a substrate (not illustrated). For example, the first OIS coil portion 512 and the second OIS coil portion 522 may be disposed on the substrate (not illustrated) so as to face the first OIS magnet 511 and the second OIS magnet 521.

The substrate (not illustrated) may be mounted on a lower surface of the housing 110, and the first OIS coil portion 512 and the second OIS coil portion 522 may directly face the first OIS magnet 511 and the second OIS magnet 521 through openings provided in the housing 110.

Alternatively, the first OIS coil portion 512 and the second OIS coil portion 522 may be disposed on a printed circuit board 720 on which the image sensor 710 is mounted (see FIG. 2).

During the image stabilization, the second OIS magnet 521 is a moving member mounted on the OIS carrier 230, and the second OIS coil portion 522 is a fixed member fixed to the housing 110.

The second OIS magnet 521 and the second OIS coil portion 522 may generate a driving force in a direction (for example, the second axis (Y-axis) direction) perpendicular to the direction in which the second OIS magnet 521 and the second OIS coil portion 522 face each other.

When power is applied to the second OIS coil portion 522, the lens module 200 and the OIS carrier 230 may be moved in the second axis (Y-axis) direction by an electromagnetic force generated between the second OIS magnet 521 and the second OIS coil portion 522.

The first OIS magnet 511 and the second OIS magnet 521 are disposed perpendicular to each other on a plane perpendicular to the optical axis (Z-axis) direction, and the first OIS coil portion 512 and the second OIS coil portion 522 are also disposed perpendicular to each other on a plane perpendicular to the optical axis (Z-axis) direction.

A second guide unit G2 is disposed between the OIS carrier 230 and the housing 110.

In an embodiment, the second guide unit G2 may include a plurality of balls. The plurality of balls may roll in the direction perpendicular to the optical axis (Z-axis) direction when the OIS carrier 230 moves in the direction perpendicular to the optical axis (Z-axis) direction.

The second guide unit G2 includes three or more balls.

A second yoke 514 and a third yoke 524 may be disposed on the housing 110. The second yoke 514 is disposed to face the first OIS magnet 511 in the optical axis (Z-axis) direction, and the third yoke 524 is disposed to face the second OIS magnet 521 in the optical axis (Z-axis) direction.

Accordingly, an attractive force is generated in the optical axis (Z-axis) direction between the second yoke 514 and the first OIS magnet 511, and an attractive force is generated in the optical axis (Z-axis) direction between the third yoke 524 and the second OIS magnet 521.

Accordingly, the OIS carrier 230 and the housing 110 may be held in contact with the second guide unit G2 by these attractive forces.

The second yoke 514 and the third yoke 524 may each be a magnetic body.

A second guide groove gr2 may be formed in either one or both of the OIS carrier 230 and the housing 110.

For example, the second guide groove gr2 may be formed in a surface of the OIS carrier 230 and a surface of the housing 110 that face each other.

A plurality of second guide grooves gr2 are formed to correspond to the plurality of balls of the second guide unit G2.

The second guide unit G2 is accommodated in the second guide grooves gr2 and is interposed between the OIS carrier 230 and the housing 110.

A size of the second guide grooves gr2 is greater than a diameter of each of the plurality of balls of the second guide unit G2. For example, a planar shape of the second guide grooves gr2 may be circular or polygonal.

In an embodiment, the camera module 2 may detect a position of the OIS carrier 230 in the direction perpendicular to the optical axis (Z-axis) direction.

For this purpose, a first position sensor 513 and a second position sensor 523 are provided. The first position sensor 513 may be disposed on a substrate (not illustrated) to face the first OIS magnet 511, and the second position sensor 523 may be disposed on the substrate (not illustrated) to face the second OIS magnet 521. The first position sensor 513 and the second position sensor 523 may be Hall sensors.

Alternatively, the first position sensor 513 and the second position sensor 523 may be disposed on the printed circuit board 720 on which the image sensor 710 is mounted (see FIG. 2).

Either one or both of the first position sensor 513 and the second position sensor 523 may include two Hall sensors.

For example, the first position sensor 513 may include two Hall sensors disposed to face the first OIS magnet 511. One of the two Hall sensors may be disposed in a hole of the first sub-coil 512a, and the other one of the two Hall sensors may be disposed in a hole of the second sub-coil 512b.

Through the two Hall sensors facing the first OIS magnet 511, it is possible to detect whether the OIS carrier 230 is rotated.

Since the first OIS coil portion 512 includes two coils facing the first OIS magnet 511, the first OIS coil portion 512 may be controlled to offset a rotational force applied to the OIS carrier 230.

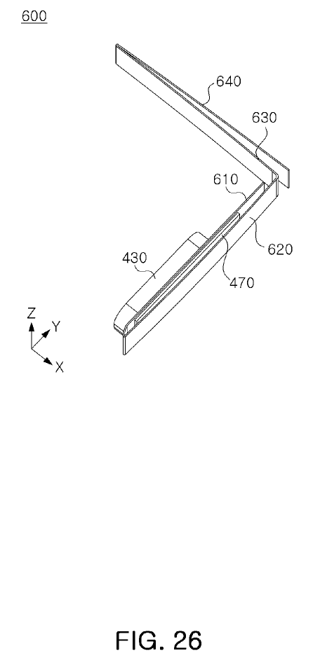

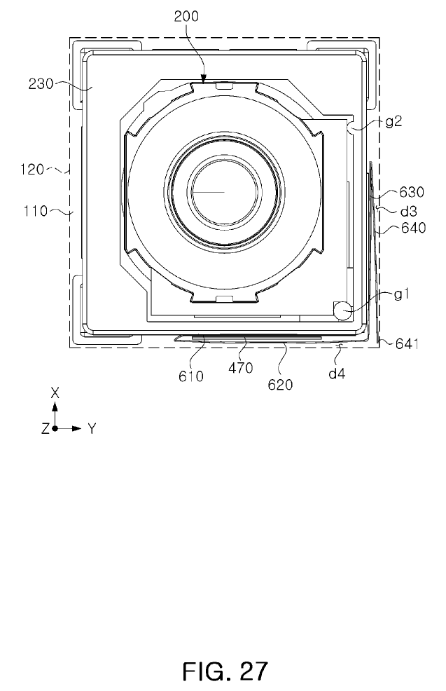

FIG. 26 is a perspective view of a connection substrate of FIG. 15. and FIG. 27 is a plan view of the connection substrate of FIG. 15 in a coupled state.

Referring to FIGS. 26 and 27, the AF coil 430 facing the AF magnet 410 may be disposed on the OIS carrier 230 that is a movable member. Accordingly, the connection substrate 600 on which the AF coil 430 is disposed may be configured to support the movement of the OIS carrier 230.

At least a portion of the connection substrate 600 may be made of a flexible material. The flexible material may be suitable for supporting the movement of the OIS carrier 230.

The connection substrate 600 may have a shape bent multiple times and may be disposed in a space between the OIS carrier 230 and the case 120.

The connection substrate 600 may include four portions disposed at different positions between the OIS carrier 230 and the case 120, and may be bent at boundaries of the four portions.

The four portions may include a first portion 610, a second portion 620, a third portion 630, and a fourth portion 640. When the connection substrate 600 is unfolded, the first portion 610, the second portion 620, the third portion 630, and the fourth portion 640 may be sequentially disposed along a longitudinal direction of the connection substrate 600.

The first portion 610 may be disposed on one side surface of the OIS carrier 230 facing one side surface 301 (see FIGS. 16 and 17) of the AF carrier 300.

The AF coil 430 and the first position sensor 450 (see FIGS. 15 and 18) may be disposed on one surface of the first portion 610. The AF coil 430 and the first position sensor 450 may face the AF magnet 410 through an opening in the OIS carrier 230.

The first yoke 470 may be disposed on an opposite surface to the one surface of the first portion 610, and the first yoke 470 may face the AF magnet 410 with the AF coil 430 and the first position sensor 450 interposed therebetween.

The first portion 610 may be made of a rigid material to secure rigidity.

The second portion 620 may be a portion bent and extended from the first portion 610 so as to be disposed substantially parallel to the first portion 610.

The second portion 620 may be spaced apart from the one side surface of the OIS carrier 230 in the first axis (X-axis) direction with the first portion 610 interposed therebetween. In addition, the second portion 620 may be spaced apart from the first portion 610 in the first axis (X-axis) direction and may also be spaced apart from the first yoke 470 in the first axis (X-axis) direction. The second portion 620 may be spaced apart from the case 120 in the first axis (X-axis) direction on an opposite side of the first portion 610.

The third portion 630 may be a portion bent and extended from the second portion 620 so as to be disposed substantially perpendicular to the first portion 610 and the second portion 620.

The third portion 630 may be spaced apart from another side surface of the OIS carrier 230 facing the second side surface 302 (see FIGS. 16 and 17) of the AF carrier 300 in the second axis (Y-axis) direction. In addition, the third portion 630 may also be spaced apart in the second axis (Y-axis) direction from the second magnetic member 472 disposed on the other side surface of the OIS carrier 230.

The fourth portion 640 may be a portion bent and extended from the third portion 630 so as to be disposed substantially parallel to the third portion 630.

The fourth portion 640 may be spaced apart from the other side surface of the OIS carrier 230 in the second axis (Y-axis) direction with the third portion 630 interposed therebetween, and may also be spaced apart from the third portion 630 in the second axis (Y-axis) direction. At least a portion of the fourth portion 640 may be spaced apart from the case 120 in the second axis (Y-axis) direction on a side opposite to the third portion 630.

Although not illustrated in the drawings, a connection portion (not illustrated) configured to receive an electrical signal from the outside may be formed on the fourth portion 640.

Referring to FIG. 27, one end 641 of the fourth portion 640 may be coupled to the case 120. That is, the connection substrate 600 may elastically support the movement of the OIS carrier 230 while one end in a longitudinal direction thereof is fixed to the case 120 that is a fixed member.

In another embodiment, the one end 641 of the fourth portion 640 may be coupled to the housing 110 that is a fixed member.

As described above, since the first portion 610 of the connection substrate 600 is disposed on the OIS carrier 230, the connection substrate 600 and the OIS carrier 230 may move relative to the housing 110 in the direction perpendicular to the optical axis (Z-axis). In the connection substrate 600, the one end 641 of the fourth portion 640 coupled to the case 120 (or the housing 110) may be a fixed portion, and the remaining portions may be movable portions.

The connection substrate 600 may be disposed to be spaced apart from a bottom surface of the housing 110 in the optical axis (Z-axis) direction. Through this configuration, when the connection substrate 600 moves together with the OIS carrier 230, interference with the housing 110 may be prevented.

The connection substrate 600 may extend in a bent manner between the OIS carrier 230 and the case 120, and may be disposed to be spaced apart from the case 120 so as to support the movement of the OIS carrier 230.

Referring to FIG. 27, a portion of the fourth portion 640 of the connection substrate 600 may be disposed to be spaced apart from the case 120 by a distance d3 in the second axis (Y-axis) direction, and the second portion 620 may be disposed to be spaced apart from the case 120 by a distance d4 in the first axis (X-axis) direction.

Accordingly, when the OIS carrier 230 is moved by the second actuator 500, a tension applied to the connection substrate 600 may be alleviated.

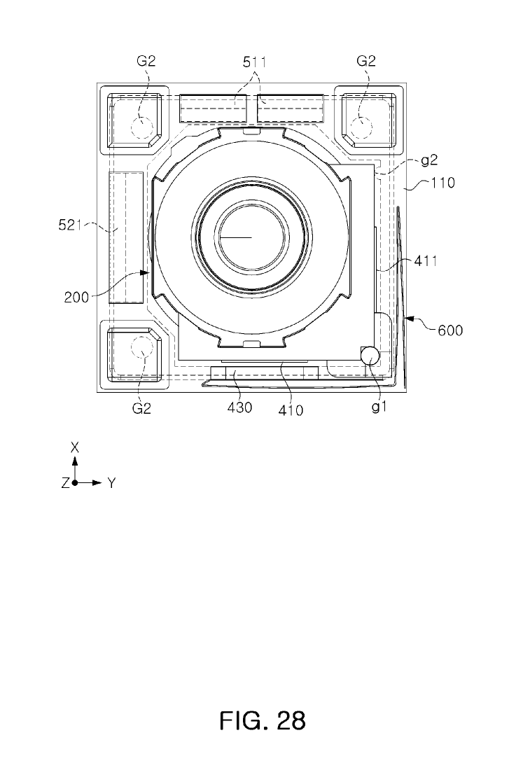

FIG. 28 is a plan view illustrating positions of a first guide unit and a second guide unit of FIG. 15.

Referring to FIG. 28, a thickness of the camera module 2 may be minimized by disposing the first guide unit G1 (the first support guide g1 and the second support guide g2), which guides the movement of the lens module 200 in the optical axis (Z-axis) direction, and the second guide unit G2, which guides the movement of the OIS carrier 230 in the direction perpendicular to the optical axis (Z-axis), so that the first guide unit G1 and the second guide unit G2 do not overlap with each other in the optical axis (Z-axis) direction.

The first support guide g1 of the first guide unit G1 may be disposed in one corner region of the camera module 2, and the second guide unit G2 may be disposed adjacent to one of the remaining corner regions of the camera module 2 excluding the one corner region.

According to the camera module according to an aspect of the present disclosure, it is possible to improve the operational stability during the focus adjustment.

While this disclosure includes specific embodiments, it will be apparent after an understanding of the disclosure of this application that various changes in form and detail may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing;
an AF carrier disposed to be movable relative to the housing in an optical axis direction;
an OIS carrier disposed to be movable relative to the housing in a direction perpendicular to the optical axis direction;
an AF actuator configured to generate a driving force in the optical axis direction and comprising an AF magnet and an AF coil disposed to face each other in a first axis direction perpendicular to the optical axis direction; and
an OIS actuator configured to generate a driving force in a direction perpendicular to the optical axis direction and comprising a plurality of OIS magnets and a plurality of OIS coils disposed to face each other,
wherein the plurality of OIS coils comprise two OIS coils spaced apart from the AF magnet in the first axis direction,
the two OIS coils are spaced apart from each other by a separation space in a second axis direction perpendicular to both the optical axis direction and the first axis direction, and
when viewed in the first axis direction, a center of the AF magnet in the second axis direction is spaced apart from the separation space between the two OIS coils in the second axis direction.

2. The camera module according to claim 1, wherein the plurality of OIS magnets comprise a first OIS magnet and a second OIS magnet,
the plurality of OIS coils comprise a first OIS coil portion facing the first OIS magnet and a second OIS coil portion facing the second OIS magnet,
the first OIS coil portion comprises a first sub-coil constituted by one of the two OIS coils and a second sub-coil constituted by another one of the two OIS coils, and
the first OIS magnet is spaced apart from the AF magnet in the first axis direction.

3. The camera module according to claim 2, wherein a distance in the second axis direction between the separation space between the first sub-coil and the second sub-coil and one surface of the second OIS magnet is smaller than a distance in the second axis direction between the center of the AF magnet and the one surface of the second OIS magnet.

4. The camera module according to claim 2, wherein a distance in the second axis direction between the center of the AF magnet and one surface of the second OIS magnet is greater than a distance in the second axis direction between a center of the first OIS magnet and the one surface of the second OIS magnet.

5. The camera module according to claim 2, wherein, when viewed in the first axis direction, the center of the AF magnet and a center of the first OIS magnet are spaced apart from each other in the second axis direction.

6. The camera module according to claim 2, wherein a ratio of a length of the first OIS magnet in the second axis direction to a length of the AF magnet in the second axis direction is greater than or equal to 0.5 and less than or equal to 1.

7. The camera module according to claim 2, further comprising:
a first position sensor configured to detect a position of the first OIS magnet; and
a second position sensor configured to detect a position of the second OIS magnet,
wherein the first position sensor comprises a plurality of position sensors.

8. The camera module according to claim 7, wherein the second OIS coil portion comprises a third sub-coil and a fourth sub-coil spaced apart from each other in the first axis direction,
a length of the third sub-coil in the first axis direction and a length of the fourth sub-coil in the first axis direction are different from each other, and
the second position sensor is disposed at a position spaced apart in the first axis direction from a center of a sub-coil having a greater length in the first axis direction among the third sub-coil and the fourth sub-coil.

9. The camera module according to claim 8, wherein a position of the second position sensor in the first axis direction is between a center of the third sub-coil and a center of the fourth sub-coil.

10. The camera module according to claim 1, further comprising a first support guide and a second support guide configured to support movement of the AF carrier in the optical axis direction and spaced apart from each other in the direction perpendicular to the optical axis direction,
wherein a position of the second support guide in the optical axis direction is between opposite ends of the first support guide in the optical axis direction, and
the center of the AF magnet is disposed closer to the first support guide than to the second support guide.

11. The camera module according to claim 10, wherein a distance in the second axis direction between the center of the AF magnet and the first support guide is different from a distance in the second axis direction between the separation space between the two OIS coils and the first support guide.

12. The camera module according to claim 1, further comprising:
a lens barrel; and
a plurality of lenses disposed in the lens barrel,
wherein the lens barrel is disposed to be movable in the optical axis direction together with the AF carrier,
the lens barrel is disposed to be movable in the direction perpendicular to the optical axis direction together with the OIS carrier, and
the center of the AF magnet and a center of the lens barrel are spaced apart from each other in the second axis direction.

13. The camera module according to claim 1, further comprising:
a lens barrel;
a plurality of lenses disposed in the lens barrel; and
an image sensor comprising an imaging surface on which light passing through the plurality of lenses disposed in the lens barrel is received,
wherein, when viewed in the optical axis direction, the center of the AF magnet is disposed at a position spaced apart from a center of the imaging surface in both the first axis direction and the second axis direction.

14. A camera module comprising:
a housing;
an AF carrier disposed to be movable relative to the housing in an optical axis direction;
an OIS carrier disposed to be movable relative to the housing in a direction perpendicular to the optical axis direction;
an AF actuator configured to generate a driving force in the optical axis direction and comprising an AF magnet and an AF coil disposed to face each other in a first axis direction perpendicular to the optical axis direction; and
an OIS actuator configured to generate a driving force in the direction perpendicular to the optical axis direction,
wherein the OIS actuator comprises a first image stabilization actuator comprising a first OIS magnet and a first OIS coil portion disposed to face each other, and a second OIS magnet and a second OIS coil portion disposed to face each other,
the first OIS coil portion is spaced apart from the AF magnet in the first axis direction,
the first OIS coil portion comprises a first sub-coil and a second sub-coil spaced apart from each other by a separation space in a second axis direction perpendicular to both the optical axis direction and the first axis direction,
a distance in the second axis direction between a center of the AF magnet and one side surface of the housing is smaller than a distance in the second axis direction between the separation space between the first sub-coil and the second sub-coil and the one side surface of the housing, and
the one side surface of the housing is a side surface closest to the AF magnet among side surfaces of the housing that are perpendicular to the AF magnet.

15. The camera module according to claim 14, further comprising a first support guide and a second support guide configured to support movement of the AF carrier in the optical axis direction and spaced apart from each other in the direction perpendicular to the optical axis direction,
wherein the AF magnet is disposed closer to the first support guide than to the second support guide, and
a distance in the second axis direction between the center of the AF magnet and the first support guide is smaller than a distance in the second axis direction between the separation space between the first sub-coil and the second sub-coil and the first support guide.
